(19) United States
(12) Patent Application Publication
(10) Pub. No.: US 2018/0109662 A1
(43) Pub. Date: Apr. 19, 2018

(54) DISPOSABLE COVERS

(71) Applicant: Scott SCHEER, Paoli, PA (US)

(72) Inventor: Scott SCHEER, Paoli, PA (US)

(21) Appl. No.: 15/567,335

(22) PCT Filed: Apr. 15, 2016
(86) PCT No.: PCT/US16/27790

§ 371 Date: Oct. 17, 2017

Related U.S. Application Data
(60) Provisional application No. 62/149,004, filed on Apr. 17, 2015.

(51) Int. Cl. H04M 1/17; H04R 1/12; A45C 13/00

(52) U.S. Cl. CPC H04M 1/17; H01H 13/86; A45C 13/002; H04R 1/12

(57) ABSTRACT

Disposable covers configured to at least partially enclose an object that includes a frequently touched surface are disclosed. The disposable cover may include a body having an inner surface that defines an interior space that is configured to receive the object such that the inner surface faces the object, an outer surface opposite the inner surface, and a multi-layer portion that includes an inner layer that is liquid impermeable, an outer layer opposite the inner layer, and an absorbent intermediate layer between the inner layer and the outer layer, the cover further defining an opening that provides access from an exterior of the disposable cover to the interior space.

### CROSS REFERENCE TO RELATED APPLICATIONS

This application claims benefit to U.S. Provisional Application No. 62/149,004, filed Apr. 17, 2015, the disclosure of which is hereby incorporated in its entirety herein.

### TECHNICAL FIELD

This disclosure relates generally to covers and, more particularly, to covers for objects with frequently touched surfaces.

### BACKGROUND

Greater emphasis is being focused on cleanliness and decreasing the bioburden of the environment in proximity to an individual, particularly in instances when the individual is in a crowded or frequently occupied area. One example of this trend includes the healthcare industry and ensuring cleanliness and reduced bioburden of the environment in proximity to acute and chronically ill patients. Another example includes the transportation industry, for example airlines or bus companies.

A challenge of healthcare facilities is keeping the environment in proximity to patients clean and disinfected. Disinfection of the healthcare environmental surfaces is becoming even more important as pathogenic microorganisms are becoming increasingly difficult to treat due to antimicrobial resistance. There are many examples of this found in a patient's care delivery room. One example of an environmental surface that is in close proximity to a patient is the hospital bed. Failure to adequately clean and maintain a decreased bioburden in the surrounding environment of patients can lead to the spread of a wide variety of infections.

Healthcare acquired infections (HAIs) have been well documented by medical literature to be transmitted between patients, healthcare workers, visitors to the healthcare facility and the surrounding environment. Many HAIs contracted secondarily to a patient's primary illness can create a significant amount of morbidity and in some cases mortality. Certain organisms, for example methicillin resistant Staphylococcus aureus (MRSA) and Clostridium difficile, are often contracted in a healthcare facility. Such infections have become ubiquitous in the community and are increasingly being contracted outside of the healthcare facility. Contraction of such infections can result in serious health ramifications.

Studies in the medical literature have attributed an increased risk of contracting a hospital-acquired infection in rooms where a current or previous occupant was colonized or infected with a pathogenic organism. Environmental surfaces have been shown to play a role in endemic transmission of certain pathogens. The presence of infectious or biohazardous material on a frequently touched surface, for example a hospital bed side rail, headboard or footboard has been well documented.

The side rails of hospital beds are traditionally fixed to the sides of the bed to prevent patients from falling from the bed. The side rails may be collapsible or movable. The headboard and footboard of hospital beds are typically not collapsible, however they can be removed, for example in the case of an emergency. The side rails, headboard and footboard of hospital beds are surfaces that are frequently touched and are in close proximity to or contact with acutely or chronically ill patients that may be infected or otherwise colonized with pathogenic microorganisms.

The result of a patient contracting an HAI may include an increased length of stay in the healthcare facility, increased and broad-spectrum antibiotic usage, an increased cost of care, the need for readmissions to the healthcare facility, closing of healthcare rooms/floors, prolonged patient illness, and significantly increase the risk of mortality.

Current guidelines recommend that health care facilities clean frequently touched surfaces on a regular basis, when spills occur, and when the surface is visibly soiled. Terminal cleaning of a room is also performed after a patient is discharged from the hospital room, however this type of cleaning may not occur for many days in between patient stays, and may not completely remove all infectious material from commonly touched surfaces. Disinfection and decontamination of an area that are currently available involves utilizing different modalities. A known practice is the physical spreading of disinfecting chemicals onto a frequently touched surface followed by manually wiping the surface. Another known practice includes dispersing or aerosolizing chemicals which land on a target frequently touched surface. A known practice includes dispersing ultraviolet radiation throughout an area that includes a frequently touched surface. Other known practices include utilizing different types of materials physically built in, or integrally a part of, the frequently touched surface to decrease or prevent microbial growth.

These known techniques do not provide a complete solution. Physical cleaning of an area with chemicals is operator dependent, and an area requiring manual cleaning may be partially or totally missed resulting in incomplete decontamination without an appropriate decrease in the bioburden. The effectiveness of ultraviolet radiation or dispersion of aerosolized chemicals into the environment is dependent on the frequently touched surfaces in the environment being exposed to the light or chemical and does not negate the need for physical cleaning. Thus, a structure, method, technique, or any combination thereof that decreases the risk of HAIs being transmitted through a frequently touched surface may result in lower costs and better outcomes for patients in crowded or frequently occupied areas, such as healthcare facilities.

In addition to the healthcare industry, greater emphasis is being focused on cleanliness and decreasing the bioburden of the environment in proximity to an individual in instances when the individual is in a crowded or frequently occupied area, such as public transportation. A challenge for providers of public transportation, such as trains, buses, airlines, etc., is keeping the environment in proximity to passengers clean and disinfected. Examples of environmental surfaces that are in close proximity to a passenger include the passenger's seat, armrest, and tray table. Failure to adequately clean and maintain a decreased bioburden in the surrounding environment of passengers can also lead to the spread of a wide variety of infections.

### SUMMARY

According to an aspect of the disclosure, a disposable cover that is configured to at least partially enclose an object that includes a frequently touch surface, comprises a body that includes an inner surface and an outer surface opposite the inner surface. The inner surface defines an interior space that is configured to receive the object such that the inner surface faces the object. The body further includes a multi-layer portion that includes an inner layer that is liquid impermeable, an outer layer that is liquid permeable and that at least partially defines the outer surface, and an intermediate layer that is disposed between the inner layer and the outer layer and that includes an absorbent material. Wherein the cover defines an opening that provides access from an exterior of the cover to the interior space.

According to another aspect of the disclosure, a disposable cover that is configured to at least partially enclose an object that includes a frequently touch surface, comprises a body that includes an inner surface and an outer surface opposite the inner surface. The inner surface defines an interior space that is configured to receive the object such that the inner surface faces the object. The body further includes a multi-layer portion that includes an inner layer that is liquid impermeable, an outer layer that is liquid permeable and that at least partially defines the outer surface, the outer layer defines a plurality of holes that provide passage through the outer layer from the outer surface toward the inner layer. Wherein the cover defines an opening that provides access from an exterior of the cover to the interior space.

According to another aspect of the disclosure, a cover that is configured to at least partially enclose an object, comprises a body that includes an outer peripheral portion and an inner portion circumferentially surrounded by the outer peripheral portion, the inner portion includes a multi-layer portion, the multi-layer portion has an inner layer, an outer layer opposite the inner layer, and an intermediate layer between the inner layer and the outer layer, the inner layer is liquid impermeable and at least partially defines an interior space that is configured to receive the object, the outer layer is liquid permeable, the intermediate layer includes an absorbent material.

### BRIEF DESCRIPTION OF THE DRAWINGS

The foregoing summary, as well as the following detailed description of illustrative embodiments of the cover of the present application, will be better understood when read in conjunction with the appended drawings. For the purposes of illustrating the cover of the present application, there is shown in the drawings illustrative embodiments. It should be understood, however, that the application is not limited to the precise arrangements and instrumentalities shown. In the drawings:

FIG. 1A is an isometric view of a cover, according to an aspect of the disclosure;

FIG. 1B is an isometric view of the cover illustrated in FIG. 1A and an enclosed object;

FIG. 2A is a cross-sectional view of a portion of the cover illustrated in FIG. 1A, along line 2-2, according to one aspect of the disclosure;

FIG. 2B is a cross-sectional view of a portion of the cover illustrated in FIG. 1A, along line 2-2, according to another aspect of the disclosure;

FIG. 3 is an isometric view of a cover according to another aspect of the disclosure and another enclosed object;

FIG. 4A is a front view of a cover according to another aspect of the disclosure and another enclosed object;

FIG. 4B is a rear view of the cover and enclosed object illustrated in FIG. 4A;

FIG. 5A is a front view of a cover according to another aspect of the disclosure and another enclosed object;

FIG. 5B is a rear view of the cover and enclosed object illustrated in FIG. 5A;

FIG. 6A is an isometric view of a cover according to another aspect of the disclosure enclosing a portion of another object;

FIG. 6B is a front view of a cover enclosing another portion of the object illustrated in FIG. 6A;

FIG. 6C is a side view of the cover enclosing the portion of the object illustrated in FIG. 6B;

FIG. 6D is an isometric view of a cover enclosing a portion of another object;

FIG. 6E is a side view of the cover enclosing the portion of the object illustrated in FIG. 6D;

FIG. 7A is a front view of a cover according to another aspect of the disclosure and another enclosed object;

FIG. 7B is a side view of the cover and enclosed object illustrated in FIG. 7A;

FIG. 7C is a front view of a cover according to another aspect of the disclosure and another enclosed object;

FIG. 8A is a front view of first and second covers according to another aspect of the disclosure and first and second enclosed portions of another object;

FIG. 8B is a front view of first and second covers according to another aspect of the disclosure and first and second enclosed portions of another object;

FIG. 8C is a front view of first and second covers according to another aspect of the disclosure and first and second enclosed portions of another object;

FIG. 9 is a front view of a cover according to another aspect of the disclosure and another enclosed object;

FIG. 10 is a front view of a cover according to another aspect of the disclosure and another enclosed object;

FIG. 11A is a top plan view of a cover according to another aspect of the disclosure and another enclosed object;

FIG. 11B is a bottom plan view of the cover and enclosed object illustrated in FIG. 11A;

FIG. 12A is a top isometric view of a cover according to another aspect of the disclosure and another enclosed object;

FIG. 12B is a bottom isometric view of the cover and enclosed object illustrated in FIG. 12A;

FIG. 12C is a side elevation view of the cover and enclosed object illustrated in FIG. 12A;

FIG. 13A is a front isometric view of a cover according to another aspect of the disclosure and another enclosed object;

FIG. 13B is a rear elevation view of the cover and enclosed object illustrated in FIG. 13A;

FIG. 14A is an isometric view of a cover according to another aspect of the disclosure and another enclosed object in a first configuration;

FIG. 14B is a bottom plan view of the cover and enclosed object illustrated in FIG. 14A, in a second configuration;

FIG. 15A is an isometric view of a cover according to another aspect of the disclosure and another enclosed object;

FIG. 15B is a side view of the cover and enclosed object illustrated in FIG. 15A;

FIG. 16A is a front view of a cover according to another aspect of the disclosure and another enclosed object;

FIG. 16B is a side view of the cover and enclosed object illustrated in FIG. 16A;

FIG. 17A is a front view of a cover according to another aspect of the disclosure and another enclosed object;

FIG. 17B is a side view of the cover and enclosed object illustrated in FIG. 17A;

FIG. 18 is an isometric view of a cover according to another aspect of the disclosure and another enclosed object;

FIG. 19A is an isometric view of a cover according to another aspect of the disclosure and another enclosed object;

FIG. 19B is a top plan view of a portion of the cover and a portion of the enclosed object illustrated in FIG. 19A;

FIG. 19C is a bottom plan view of the portion of the cover and the portion of the enclosed object illustrated in FIG. 19B;

FIG. 19D is an isometric view of a cover according to another aspect of the disclosure and another enclosed object;

FIG. 19E is a front elevation view of a portion of the cover and a portion of the enclosed object illustrated in FIG. 19D.

### DETAILED DESCRIPTION OF THE ILLUSTRATIVE EMBODIMENTS

Aspects of the disclosure will now be described in detail with reference to the drawings, wherein like reference numbers refer to like elements throughout, unless specified otherwise. Certain terminology is used in the following description for convenience only and is not limiting. The term “plurality”, as used herein, means more than one. Certain features of the disclosure which are described herein in the context of separate embodiments may also be provided in combination in a single embodiment. Conversely, various features of the disclosure that are described in the context of a single embodiment may also be provided separately or in any subcombination.

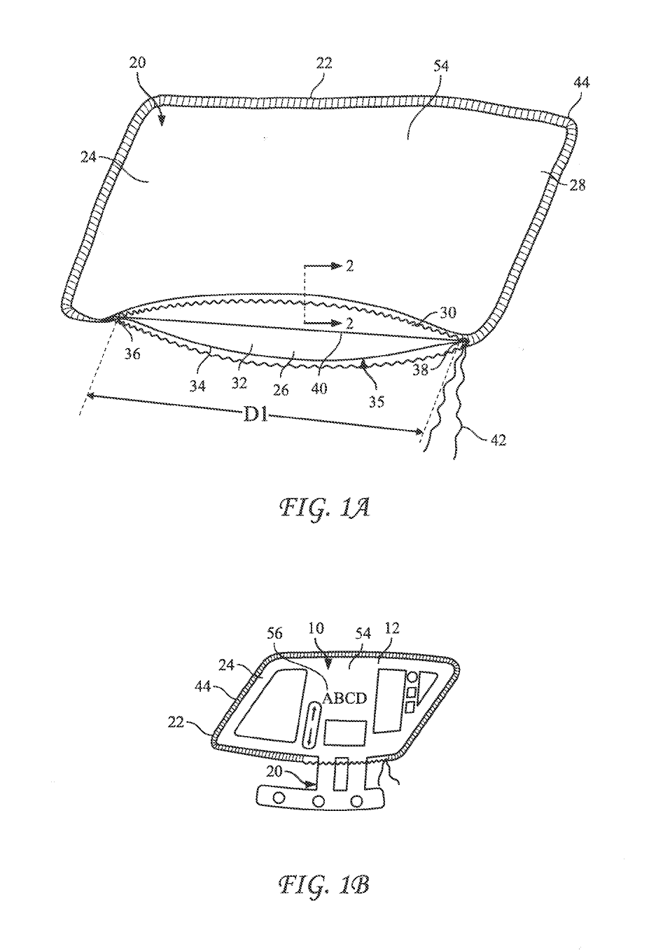

Referring to FIGS. 1A and 1B, an object 10 that includes a surface 12, for example a frequently touched surface, is enclosed, for example partially enclosed or entirely enclosed, by a cover 20, for example a disposable cover. The object 10 may be, for example, a hospital bed side rail as shown in the illustrated embodiment. According to one aspect of the disclosure, the cover 20 defines an outer perimeter 22, and the cover 20 includes a body 24 that extends to and terminates at the outer perimeter 22. The body 24 may be flexible, for example expandable, such that a size, shape, or both of the body 24 may be configured to fit a plurality of objects with various sizes and shapes. For example, the body 24 may correspond generally to a shape of a hospital bed side rail.

There are many different types of hospital beds, which are found in, among other places, acute short-term care hospitals, long-term acute care facilities, emergency rooms, outpatient surgery centers, outpatient urgent care centers, hemodialysis centers, skilled nursing facilities, nursing homes, rehabilitation facilities, in home, etc. The body 24 may correspond generally to a shape of a hospital bed side rail of a hospital bed side typically found in acute short-term care hospitals, long-term acute care facilities, emergency rooms, outpatient surgery centers, outpatient urgent care centers, hemodialysis centers, skilled nursing facilities, nursing homes, rehabilitation facilities, in home, or any combination thereof.

The size of the outer perimeter 22 may be measured from a location on the outer perimeter 22, along an entirety of the outer perimeter 22, terminating at the location. For example, the outer perimeter 22 may define a first size prior to the cover 20 enclosing the object 10, and the outer perimeter may further define a second size, that is larger than the first size, when the object 10 is enclosed by the cover 20.

The body 24 may include an inner surface 26 that is configured to face the object 10 when the cover 20 encloses the object 10, and the body 24 may further include an outer surface 28 opposite the inner surface 26. As shown in the illustrated embodiment, the inner surface 26 defines an interior space 30 that is configured to receive the object 10, for example a portion of the object 10 that includes the surface 12 or an entirety of the object 10.

According to one aspect of the disclosure the cover 20 defines an opening 32 that extends through the body 24 thereby providing access, for example for the object 10, from an exterior of the cover 20 to the interior space 30. As shown in the illustrated embodiment, the opening 32 may be defined by a first portion 34 of the body 24. The opening 32 may define a maximum dimension D1 measured from a first point 36 located in the first portion 34 to a second point 38 located in the first portion 34 along a straight line 40. The cover 20 may be configured such that a size of the maximum dimension D1 is adjustable. For example, the size of the maximum dimension D1 may be larger prior to enclosing the object 10 within the interior space 30 to facilitate insertion of the object 10 into the interior space 30, as shown in FIG. 1A. The cover 20 may be further configured such that the size of the maximum dimension D1 is smaller after the object 10 is enclosed within the interior space 30 to prevent inadvertent removal of the cover 20 from the object 10, as shown in FIG. 1B. As shown in the illustrated embodiment, the body 24 may be devoid of any additional openings that provide access from the exterior of the cover 20 to the interior space 30. Alternatively, the body 24 may include a plurality of openings 32 that each provides access from the exterior of the cover 20 to the interior space 30.

According to one aspect of the disclosure, the first portion 34 may include elements configured to facilitate opening the opening 32, closing the opening 32, changing a size of the opening 32, or any combination thereof. According to one embodiment of the disclosure, the cover 20, for example the first portion 34, includes a closing mechanism 35 configured to open the opening 32, close the opening 32, changing a size of the opening 32, or any combination thereof.

According to one embodiment, the closing mechanism 35 may include an adhesive. The adhesive can be attached to the cover 20, for example about at least a portion of a periphery of the opening 32. The adhesive may be configure to be activated, for example after insertion of the object 10 into the interior space 30, so as to reduce a size of, or entirely close, the opening 32 thereby capturing the object 10 within the interior space 30. Activation of the adhesive can include, but is not limited to: removing a cover strip from the adhesive, applying heat to the adhesive, applying light to the adhesive, applying pressure to the adhesive, or any combination thereof. The adhesive may be configured such that after activation of the adhesive, the adhesive can be overcome to re-open the opening 32 without damaging the cover 20. Alternatively, the adhesive may be configured such that after activation of the adhesive, the adhesive cannot be overcome to re-open the opening 32 without damaging the cover 20.

Inclusion of an adhesive as the closing mechanism 35 can provide flexibility in the use of the cover 20, such that the cover 20 can be placed over objects of various sizes and shapes, and the opening 32 can be closed to secure the object 10 within the interior space 30. The adhesive may be applicable to the cover 20 without significantly increasing the costs of manufacturing the cover 20.

According to one embodiment, the closing mechanism 35 may include, either instead of or in addition to the adhesive, other mechanical mechanisms such as a sliderless zipper, plastic buttons built in to the cover 20, or grommets built in to the cover 20.

According to one embodiment, the closing mechanism may include, either instead of or in addition to the adhesive, an elastic material. The elastic material may be configured such that the size of the maximum dimension D1 is biased to a smaller size, and the bias can be overcome to increase the size of the maximum dimension D1 to facilitate insertion of the object 10 into the interior space 30. Alternatively, or in addition to elastic material, the first portion 34 may include a string 42, such as a draw string, or another structure or material known to facilitate changing the size of the maximum dimension D1 of the opening 32 and to further facilitate a secure closure of the cover 20 when the object 10 is positioned within the interior space 30.

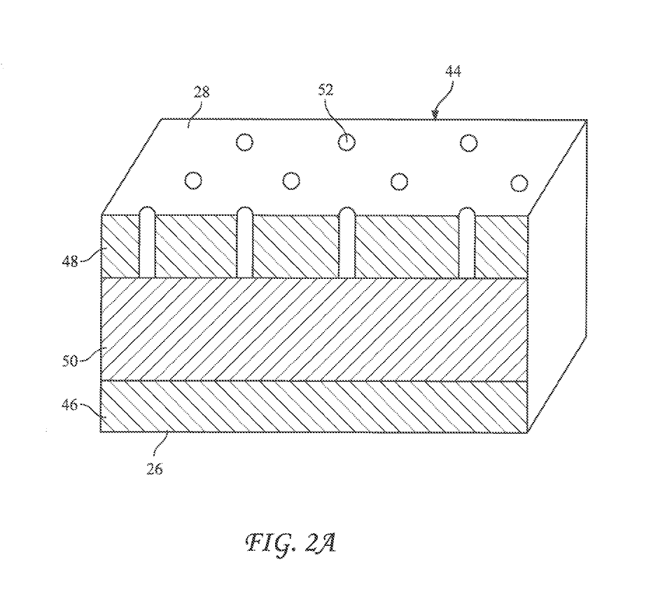

Referring to FIG. 2A, the body 24 may include a multi-layer portion 44 that includes a plurality of layers between the inner surface 26 and the outer surface 28. According to one aspect of the disclosure, the multi-layer portion 44 includes a first layer 46, for example an inner layer, that at least partially defines the inner surface 26 and a second layer 48, for example an outer layer, that at least partially defines the outer surface 28. The multi-layer portion 44 may further define a third layer 50, for example one or more intermediate layers, between the first layer 46 and the second layer 48. The first layer 46 may be liquid impermeable, the second layer 48 may be liquid permeable, the third layer 50 may be absorbent, or any combination thereof.

As shown in the illustrated embodiment, the second layer 48 may include a plurality of holes 52 that provide passage, for example for liquids, from the outer surface 28 through the second layer 48 to the third layer 50. The second layer 48 may be configured such that liquids or other substances that contact the outer surface 28 pass through the plurality of holes 52 and are thereby absorbed and retained in the third layer 50.

Referring to FIG. 2B, according to one aspect of the disclosure, the multi-layer portion 44 may include a plurality of first layers 46, a plurality of second layers 48, a plurality of third layers 50, or any combination thereof. For example, the multi-layer portion 44 may include a first set of layers 51a that includes one of the first layers 46, one of the second layers 48, and one of the third layers 50 positioned between the first layer 46 of the first set of layers 51a and the second layer 48 of the first set of layers 51a. The multi-layer portion may further include a second set of layers 51b that includes another of the first layers 46, another of the second layers 48, and another of the third layers 50 positioned between the first layer 46 of the second set of layers 51b and the second layer 48 of the second set of layers 51b.

As shown the first and second sets of layers 51a and 51b may be arranged such that the second layer 48 of the first set of layers 51a defines the outer surface 28 and the first layer 46 of the second set of layers 51b defines the inner surface 26. The first set of layers 51a may be configured to be removed by hand, without the use of tools, and without damaging the second set of layers 51b. According to one aspect of the disclosure, the multi-layer portion 44 may include additional sets of layers, for example a third set of layers, a fourth set of layers, etc.

Referring to FIG. 1A, according to one aspect of the disclosure, one section or a plurality of separate sections of the body 24 can define the multi-layer portion 44. Alternatively, an entirety of the body 24 can define the multi-layer portion 44. As shown, the multi-layer portion 44 is positioned at the outer perimeter 22, for example such that the multi-layer portion 44 at least partially defines the outer perimeter 22 of the cover 20. The multi-layer portion 44 may be configured such that when the cover 20 encloses the object 10 within the interior space 30, the multi-layer portion 44 aligns with a frequently touched surface of the object 10. For example, the cover 20 may include a multi-layer portion 44 that is configured to be aligned with an outer perimeter of a hospital bed side rail when the hospital bed side rail is enclosed within the interior space 30 of the cover 20.

Referring to FIGS. 1A and 1B, according to one aspect of the disclosure, the body 24 may include a transparent portion 54 that is configured such that markings, for example words, numbers, pictures, etc., on the object 10 are visible, for example at least partially visible, from the exterior of the cover 20, through the transparent portion 54 when the object 10 is enclosed within the interior space 30 (hereinafter referred to as transparent). The transparent portion 54 may include a single, liquid impermeable layer. One or more separate sections of the body 24 can define the transparent portion 54. Alternatively, the entirety of the body 24 can define the transparent portion 54 such that the body 24 is devoid of the multi-layer portion 44. As shown, the transparent portion 54 is surrounded by the multi-layer portion 44. Also as shown, a first area of the body 24 that defines the transparent portion 54 may be larger than a second area of the body 24 that defines the multi-layer portion 44. The transparent portion 54 can make up any percentage of the body 24, for example between 0% and 100%.

According to one aspect of the disclosure, the cover 20 (and any of the covers mentioned herein) may include an antimicrobial property, for example carried by the inner surface 26, the outer surface 28, the first layer 46, the second layer 48, the third layer 50, or any combination thereof. The cover 20 may include other substances, fibers, or particles including silver, copper, particles incorporating nano technology, or any combination thereof. The cover 20 may be configured to be puncture resistant, the cover 20 may include an adhesive, for example carried by the inner surface 26, the cover 20 may include printing, for example carried by the outer surface 28, the cover 20 may include at least a portion that is colored one of a plurality of colors, the plurality of colors being part of a coded system wherein each of the plurality of colors indicates information about a person, for example allergies of a patient, in proximity to the object 10 enclosed by the cover 20, or any combination thereof. According to one aspect of the disclosure, the transparent portion 54 may be colored one or more of the plurality of colors such that the transparent portion 54 remains transparent.

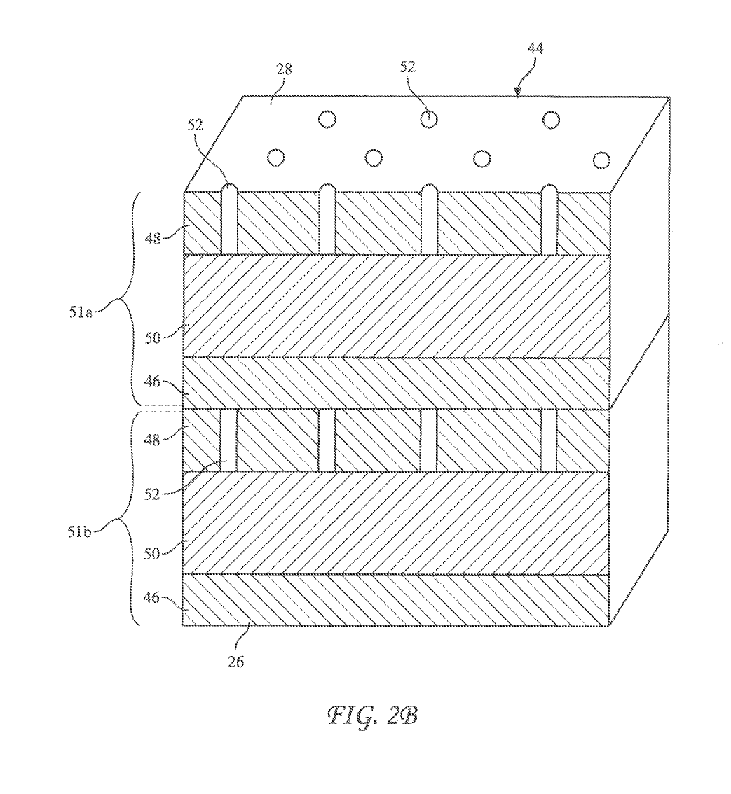

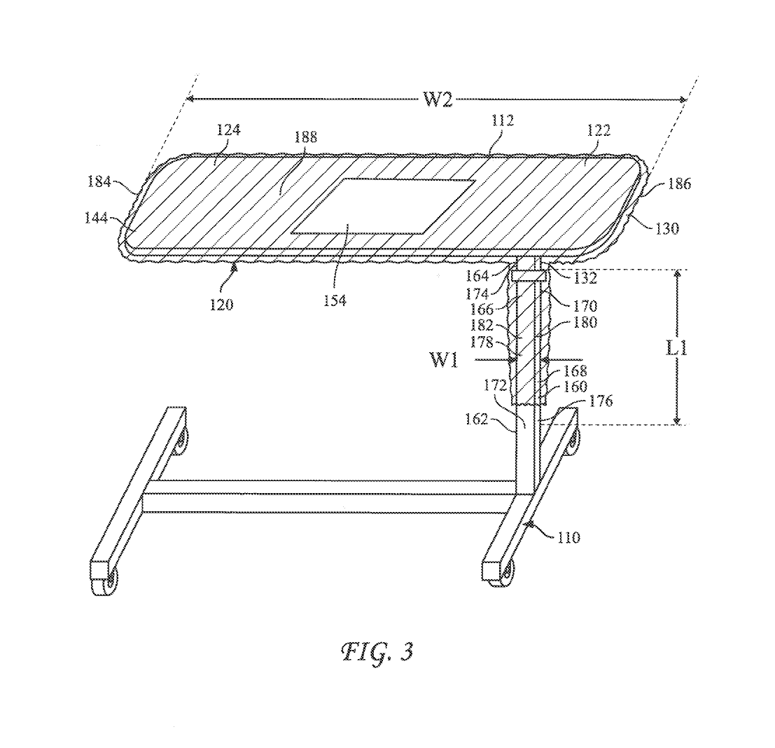

Referring to FIG. 3, an object 110 that includes a surface 112, for example a frequently touched surface, is enclosed, for example partially enclosed or entirely enclosed, by a cover 120. The object 110 may be, for example, a hospital bed tray table as shown in the illustrated embodiment. The cover 120 may be configured similarly to the cover 20 (described in detail in reference to FIGS. 1A to 2B above) in many aspects such that the description of the cover 20 herein can be applied to the cover 120, and vice versa. Some similar elements of the cover 120 are identified below bearing the same reference numbers as the corresponding elements of the cover 20, but increased by 100. Differences between the cover 120 and the cover 20 are also described below.

According to one aspect of the disclosure, the cover 120 defines an outer perimeter 122, and the cover 120 includes a body 124 that extends to and terminates at the outer perimeter 122. The body 124 may be flexible, for example expandable, such that a size, shape, or both of the body 124 may be configured to fit a plurality of objects with various sizes and shapes. For example, the body 124 may correspond generally to a shape of a hospital bed tray table.

According to one aspect of the disclosure, an entirety of the body 124 can define the multi-layer portion 144 and the body 124 is devoid of a transparent portion 154. According to one aspect of the disclosure, an entirety of the body 124 can define the transparent portion 154 and the body 124 is devoid of the multi-layer portion 144. Alternatively, a portion of the body 124 can define the multi-layer portion 144 and the body 124 can include a transparent portion 154. The transparent portion 154 can make up any percentage of the body 124, for example between 0% and 100%. For example, the cover 120 can be configured to enclose a hospital bed tray table such that the multi-layer portion 144 is substantially aligned with and substantially covers an upper eating surface of the hospital bed tray table, a transparent portion 154 is aligned with a lower surface opposite the upper eating surface of the hospital bed tray table, or both.

According to one aspect of the disclosure, the cover 120 includes a sleeve 160 that includes a first end 162, a second end 164 opposite the first end 162, and a sleeve member 166 that extends from the first end 162 to the second end 164. The sleeve 160 may further include an inner surface 168 that defines a passage 170 that extends through the sleeve member 166 from the first end 162 to the second end 164.

The sleeve 160 may be coupled to the body 124 such that the second end 164 is adjacent to and aligned with an opening 132 such that the passage 170 provides access, for example for the object 110, from an exterior of the cover 120, through the passage 170, through the opening 132, and into an interior space 130. The sleeve 160 may be detachably couplable to the body 124, for example the sleeve 160 and the body 124 may include adhesive portions, Velcro portions, or some other portion configured to detachably couple the sleeve 160 to the body 124. The sleeve 160 may define a split ring shape such that the sleeve 160 is configured to be positioned around a portion of the object 110, such as a leg of the hospital bed tray table. The sleeve can include a transparent portion (similar to the transparent portion 154), a multi-layer portion (similar to the multi-layer portion 144), or both. The sleeve 160 may include elastic material such that the sleeve 160 is flexible, for example expandable such that a size, shape, or both of the sleeve 160 may be configured to fit a portion of a plurality of objects with various sizes and shapes.

The sleeve 160 defines a length L1 measured from a point 172 on the first end 162 to a point 174 on the second end 164 along a straight line 176. The sleeve 160 may further define a width W1 measured from a point 178 on the sleeve 160, through the passage 170, to a point 180 on the sleeve 160 along a straight line 182 that is perpendicular to the straight line 176. The length L1 may be greater than the width W1, as shown in the illustrated embodiment. An entirety, a portion, or none of the length L1 may be defined by a multi-layer portion (similar to the multi-layer portion 144).

The multi-layer portion 144 defines a width W2 measured from a point 184 on the multi-layer portion 144 to a point 186 on the multi-layer portion 144 along a straight line 188 that is perpendicular to the straight line 176. The width W2 may be greater than the width W1, greater than the length L1, or both.

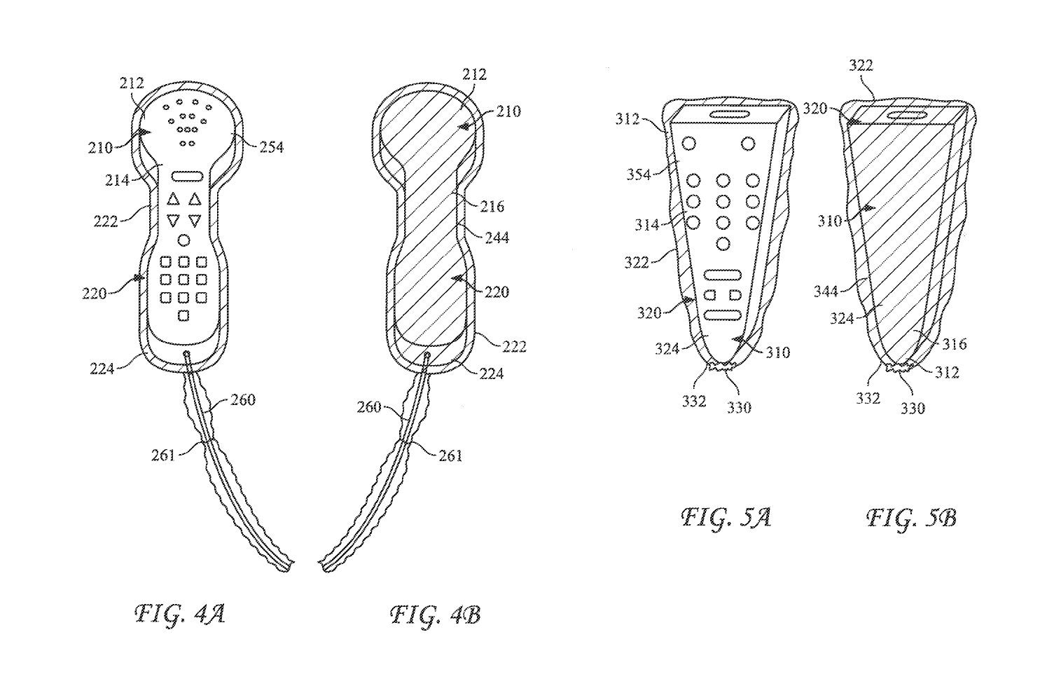

Referring to FIGS. 4A-4B, an object 210 that includes a surface 212, for example a frequently touched surface, is enclosed, for example partially enclosed or entirely enclosed, by a cover 220. The object 210 may be, for example, a wired remote control as shown in the illustrated embodiment. The cover 220 may be configured similarly to the cover 20 (described in detail in reference to FIGS. 1A to 2B) and the cover 120 (described in detail in reference to FIG. 3 above) in many aspects such that the descriptions of the cover 20 and the cover 120 herein can be applied to the cover 220, and vice versa. Some similar elements of the cover 220 are identified below bearing the same reference numbers as the corresponding elements of the cover 20 and the cover 120, but increased by 200 and 100, respectively. Differences between the cover 220 and the covers 20 and 120 are also described below.

According to one aspect of the disclosure, the cover 220 defines an outer perimeter 222, and the cover 220 includes a body 224 that extends to and terminates at the outer perimeter 222. The body 224 may be flexible, for example expandable, such that a size, shape, or both of the body 224 may be configured to fit a plurality of objects with various sizes and shapes. For example, the body 224 may correspond generally to a shape of a remote control, for example a wired remote control.

The body 224 includes a multi-layer portion 244 that may include a transparent portion 254 a multi-layer portion 244. According to one aspect of the disclosure, the cover 220 is configured to enclose the object 210 such that the transparent portion 254 faces a front surface 214 of the object 210, for example the input controls on the remote control, and the multi-layer portion 244 faces a rear surface 216 of the object 210, for example a surface of the remote control that is devoid of input controls. The cover 220 enclosing the remote control as described above allows a user of the remote control to see the input controls through the transparent portion 254, while still providing the multi-layer portion 244 facing the remainder of the remote control that is devoid of input controls thereby providing a decreased bioburden for the remote control. As shown about half of the body 224 defines the multi-layer portion 244 and about half of the body 224 defines the transparent portion 254.

The cover 220 may include a sleeve 260 configured to enclose for example partially enclose or entirely enclose, a portion of the object 210, for example a wire of the remote control. The sleeve 260 may include a mechanism 261 configured to constrict the sleeve 260 about the portion of the object 210 enclosed in the sleeve 260. The mechanism 261 can include, for example, an elastic band configured to constrict the sleeve 260 around the wire of the remote control.

Referring to FIGS. 5A-5B, an object 310 that includes a surface 312, for example a frequently touched surface, is enclosed, for example partially enclosed or entirely enclosed, by a cover 320. The object 310 may be, for example, a wireless remote control as shown in the illustrated embodiment. The cover 320 may be configured similarly to the cover 220 (described in detail in reference to FIGS. 4A and 4B above) in many aspects such that the descriptions of the cover 320 (in addition to the descriptions of the covers 20 and 120) herein can be applied to the cover 320, and vice versa. Some similar elements of the cover 320 are identified below bearing the same reference numbers as the corresponding elements of the cover 220, but increased by 100. Differences between the cover 320 and the cover 220 are also described below.

According to one aspect of the disclosure, the cover 320 defines an outer perimeter 322, and the cover 320 includes a body 324 that extends to and terminates at the outer perimeter 322. The body 324 may be flexible, for example expandable, such that a size, shape, or both of the body 324 may be configured to fit a plurality of objects with various sizes and shapes. For example, the body 324 may correspond generally to a shape of a remote control, for example a wireless remote control. According to one aspect of the disclosure the cover 320 defines an opening 332 that extends through the body 324 thereby providing access, for example for the object 310, from an exterior of the cover 320 to an interior space 330. As shown in the illustrated embodiment, the opening 332 may be configured such that a size the opening 332 is adjustable. The body 324 may include an elastic material that at least partially defines the opening 332 to facilitate the adjustable size the opening 332.

The body 324 may include a multi-layer portion 344 and a transparent portion 354. According to one aspect of the disclosure, the cover 320 is configured to enclose the object 310 such that the transparent portion 354 faces a front surface 314 of the object 310, for example the input controls on the remote control, and the multi-layer portion 344 faces a rear surface 316 of the object 310, for example a surface of the remote control that is devoid of input controls. The multi-layer portion 344 may further face a side surface of the remote control that extends between the front surface 314 and the rear surface 316. The cover 220 enclosing the remote control as described above allows a user of the remote control to see the input controls through the transparent portion 354, while still providing the multi-layer portion 244 facing the remainder of the remote control that is devoid of input controls thereby providing a decreased pathogenic bioburden for the surface of the remote control. As shown about half of the body 324 defines the multi-layer portion 344 and about half of the body 324 defines the transparent portion 254. As shown, the cover 320 may be devoid of any sleeves (such as the sleeve 160 shown in FIG. 3).

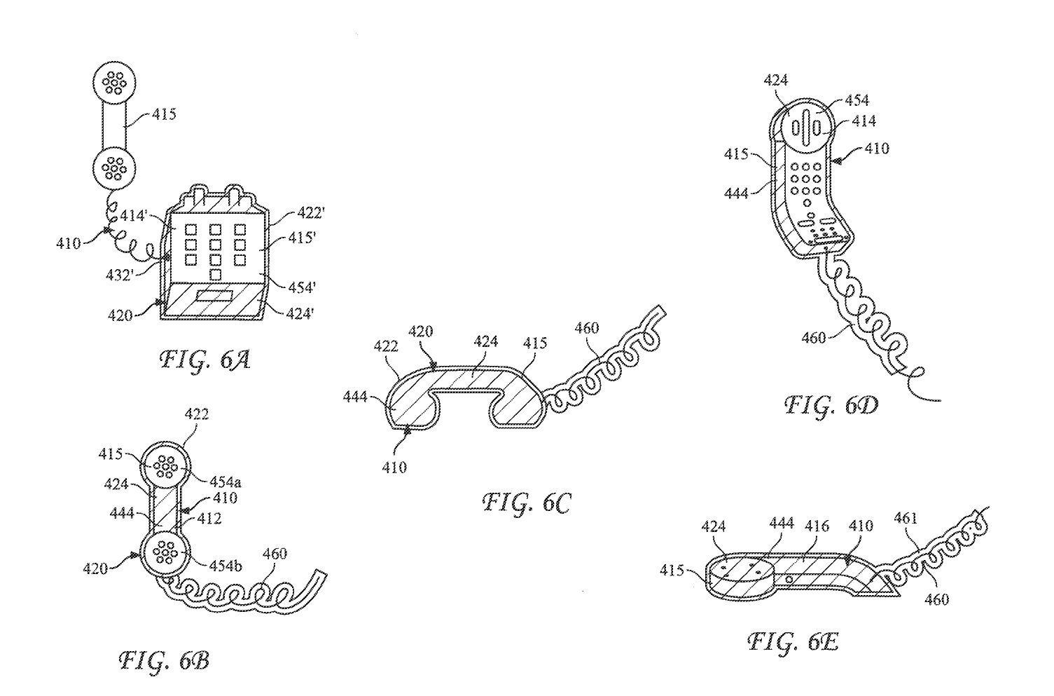

Referring to FIGS. 6A-6E, an object 410 that includes a surface 412, for example a frequently touched surface, is enclosed, for example partially enclosed or entirely enclosed, by a cover 420. The object 410 may include a first portion 415 and a second portion 415′. The object 410 may be a telephone including a first portion 415 in the form of a handset and a second portion 415′ in the form of a base unit. The object 410 may be, for example, a tabletop telephone as shown in FIGS. 6A-6C, or a wall mounted telephone as shown in FIGS. 6D-6E. The cover 420 may be configured similarly to the covers 20, 120, 220, and 320 (described in detail in reference to FIGS. 1A-5B above) in many aspects such that the descriptions of the covers 20, 120, 220 and 320 herein can be applied to the cover 420, and vice versa. Some similar elements of the cover 420 are identified below bearing the same reference numbers as the corresponding elements of the covers 20, 120, 220, and 320 but increased by 400, 300, 200, and 100, respectively. Differences between the cover 420 and the covers 20, 120, 220, and 320 are also described below.

According to one aspect of the disclosure, the cover 420 defines a first outer perimeter 422, and the cover 420 includes a first body 424 that extends to and terminates at the first outer perimeter 422. The cover 420 may further define a second outer perimeter 422′, and the cover 420 may further include a second body 424′ that extends to and terminates at the second outer perimeter 422′. The first and second bodies 424 and 424′ may each be flexible, for example expandable, such that a size, shape, or both of the first and second bodies 424 and 424′ may be configured to fit a plurality of objects with various sizes and shapes. For example, the first body 424 may correspond generally to a shape of a handset, or receiver, of a telephone, and the second body 424′ may correspond generally to a shape of a base unit of a telephone.

Referring to FIGS. 6B and 6C, according to one aspect of the disclosure, the first body 424 is configured to enclose a first portion 415 of the object 410, and the first body 424 includes a transparent portion 454 that includes a plurality sub-portions, including a first sub-portion 454a and a second sub-portion 454b. The first body 424 may further include a multi-layer portion 444. As shown, the first sub-portion 454a and the second sub-portion 454b are spaced apart from one another, for example by the multi-layer portion 444. The first body 424 may be configured such that the first (transparent) sub-portion 454a and the second (transparent) sub-portion 454b are each aligned with a respective speaker and microphone of the handset when the cover 420 encloses the object 410. The multi-layer portion 444 may be aligned with a remainder, up to an entirety of the remainder of the handset. The cover 420 may include a first sleeve 460 configured to be coupled to the first body 424 such that the first sleeve 460 encloses at least a portion of a cord of the telephone when the cover 420 encloses the telephone. The sleeve 460 can include the same material as the multi-layer portion 444, the same material as the transparent portion 454, or a portion that has the same material as the multi-layer portion 444 and a portion that has the same material as the transparent portion 454.

Referring to FIGS. 6D and 6E, according to one aspect of the disclosure, the first body 424 is configured to enclose the first portion 415 of the object 410 such that the transparent portion 454 is aligned with a front surface 414 of the first portion 415 of the object 410, for example a surface that includes the input controls on and the speakers on the handset, and the multi-layer portion 444 surrounds the transparent portion 454 and faces a rear surface 416 of the first portion 415 of the object 410, for example a surface of the handset that is devoid of input controls. As shown the cover 420 may include a first sleeve 460 configured to be coupled to the first body 424 such that the first sleeve 460 encloses at least a portion of a cord of the telephone when the cover 420 encloses the telephone. The sleeve 460 may include a mechanism 461 configured to constrict the sleeve 460 about the portion of the object 410 enclosed in the sleeve 460. The mechanism 261 can include, for example, an elastic band configured to constrict the sleeve 460 around the cord of the telephone. As shown in the illustrated embodiment, the mechanism 461 can include an elastic band that is would around the sleeve 460 along at least a portion up to an entirety of the sleeve 460.

Referring to FIG. 6A, according to one aspect of the disclosure, the second body 424′ includes a transparent portion 454′ and a multi-layer portion 444′. The cover 420 may be configured to enclose the object 410 such that the transparent portion 454′ faces a front surface 414′ of the second portion 415′ of the object 410, for example the input controls on the base unit, and the multi-layer portion 444′ faces a remainder of the second portion 415′ of the object 410, for example a surface of the base unit that is devoid of input controls. The second body 424′ may further be configured such that a cord of the telephone extends from the base unit and passes through an opening 432′ of the second body 424′.

According to one aspect of the disclosure, the cover 420 may include a sleeve 460 configured to enclose for example partially enclose or entirely enclose, a portion of the object 410, for example a cord of the telephone. The sleeve 460 may extend from the first body 424 toward the second body 424′, from the second body 424′ toward the first body 424, or the sleeve 460 may be connected to both the first body 424 and the second body 424′ such that an entirety of the cord is enclosed and the first and second bodies 424 and 424′ are joined by the sleeve 460. The first body 424, second body 424′, and sleeve 460 may be placed on the respective portions of the object 410 separately. For example, the first body 424 may be placed to enclose the handset of a phone, and after the first body 424 has enclosed the handset 424 the second body 424′ may separately be placed to enclose the base unit of the phone.

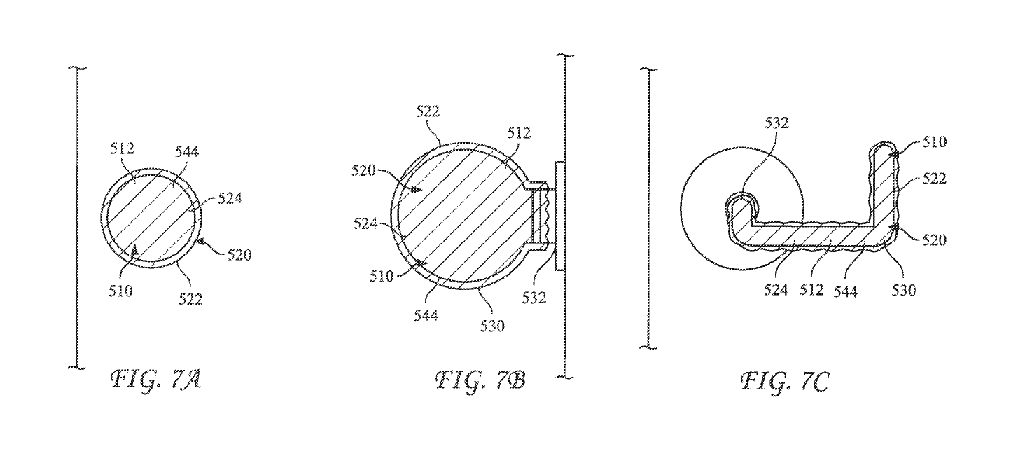

Referring to FIGS. 7A-7C, an object 510 that includes a surface 512, for example a frequently touched surface, is enclosed, for example partially enclosed or entirely enclosed, by a cover 520. The object 510 may be, for example, a door knob or door handle as shown in the illustrated embodiments. The cover 520 may be configured similarly to the covers 20, 120, 220, 320, and 420 (described in detail in reference to FIGS. 1A-6E above) in many aspects such that the descriptions of the covers 20, 120, 220, 320, and 420 herein can be applied to the cover 520, and vice versa. Some similar elements of the cover 520 are identified below bearing the same reference numbers as the corresponding elements of the covers 20, 120, 220, 320, and 420, but increased by 500, 400, 300, 200, and 100, respectively. Differences between the cover 520 and the covers 20, 120, 220, 320, and 420 are also described below.

Referring to FIGS. 7A and 7B, according to one aspect of the disclosure, the cover 520 defines an outer perimeter 522, and the cover 520 includes a body 524 that extends to and terminates at the outer perimeter 522. The body 524 may be flexible, for example expandable, such that a size, shape, or both of the body 524 may be configured to fit a plurality of objects with various sizes and shapes. For example, the body 524 may correspond generally to a shape of a door knob, for example a substantially spherical door knob. The body 524 includes a multi-layer portion 544. As shown, substantially an entirety of the body 524 defines the multi-layer portion 544. The body 524 may be devoid of a transparent portion (similar to the transparent portion 54 as described above). The body 524 may include an opening 532 configured to enlarge during insertion of the object 510 through the opening 532 and into the enclosed interior 530.

Referring to FIG. 7C, according to one aspect of the disclosure, the cover 520 defines an outer perimeter 522, and the cover 520 includes a body 524 that extends to and terminates at the outer perimeter 522. The body 524 may be flexible, for example expandable, such that a size, shape, or both of the body 524 may be configured to fit a plurality of objects with various sizes and shapes. For example, the body 524 may correspond generally to a shape of a door handle, for example a substantially L-Shaped door knob. As shown, substantially an entirety of the body 524 defines the multi-layer portion 544. The body 524 may be devoid of a transparent portion (similar to the transparent portion 54 as described above). The body 524 may include an opening 532 configured to enlarge during insertion of the object 510 through the opening 532 and into the enclosed interior 530. The opening 532 may include a mechanism configured to secure the cover 520 on to the object 510, such as an elastic band that at least partially surrounds the opening 532. According to one aspect of the disclosure, the body 524 can include a sticky or adhesive coating on a surface that faces the object 510 when the cover 520 encloses the object 510.

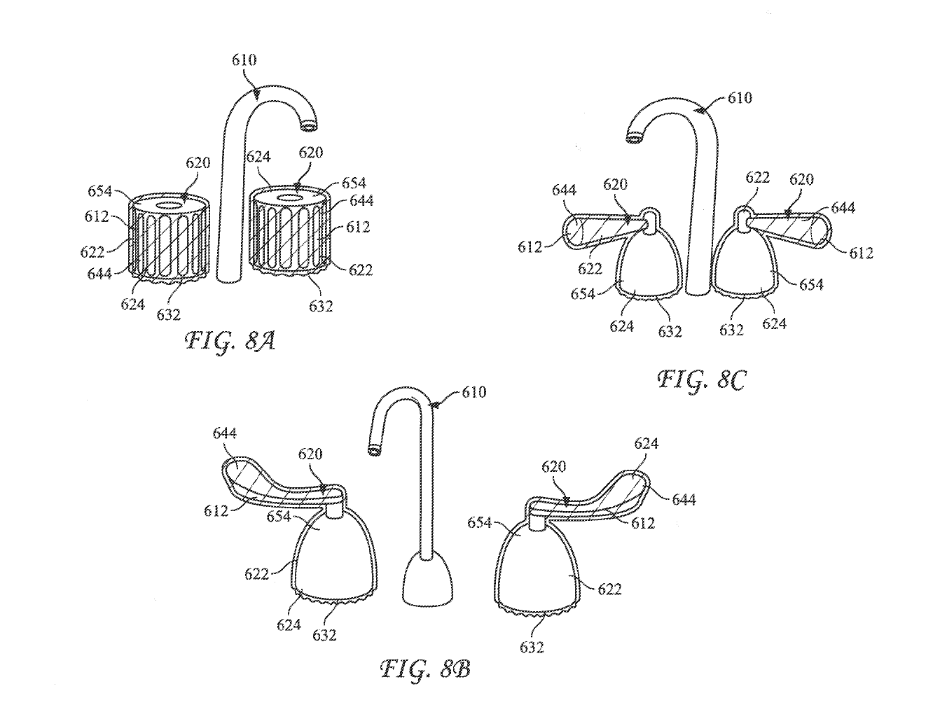

Referring to FIGS. 8A-8C, an object 610 that includes a plurality of surfaces 612, for example a first frequently touched surface and a second frequently touched surface, is enclosed, for example partially enclosed or entirely enclosed, by a plurality of covers 620. The object 610 may be, for example, a faucet as shown in the illustrated embodiment. The plurality of covers 620 may each be configured similarly to the covers 20, 120, 220, 320, 420, and 520 (described in detail in reference to FIGS. 1A-7C above) in many aspects such that the descriptions of the covers 20, 120, 220, 320, 420, and 520 herein can be applied to each of the plurality of covers 620, and vice versa. Some similar elements of the plurality of covers 620 are identified below bearing the same reference numbers as the corresponding elements of the covers 20, 120, 220, 320, 420, and 520, but increased by 600, 500, 400, 300, 200, and 100, respectively. Differences between the plurality of covers 620 and the covers 20, 120, 220, 320, 420, and 520 are also described below.

According to one aspect of the disclosure, the plurality of covers 620 includes two covers 620. Each of the plurality of covers 620 defines a respective outer perimeter 622, and each of the plurality of covers 620 includes a respective body 624 that extends to and terminates at the respective outer perimeter 622. Each of the bodies 624 may be flexible, for example expandable, such that a size, shape, or both of the body 624 may be configured to fit a plurality of objects with various sizes and shapes. For example, each of the bodies 624 may correspond generally to a shape of a handle, for example a knob or lever shaped handle of a faucet.

Each of the plurality of covers 620 can include a multi-layer portion 644 and a transparent portion 654. The multi-layer portion 644 may be positioned closer to an opening 632 of the cover 620, than the transparent portion 654 is positioned to the opening 632, as shown in FIG. 8A. Alternatively, the multi-layer portion 644 may be positioned farther from the opening 632 of the cover 620, than the transparent portion 654 is positioned from the opening 632, as shown in FIG. 8B. Alternatively, the multi-layer portion 644 may be positioned closer to the opening 632 of the cover 620, than a portion of the transparent portion 654 is positioned to the opening 632, and the multi-layer portion 644 may be positioned farther from the opening 632 of the cover 620, than another portion of the transparent portion 654 is positioned from the opening 632, as shown in FIG. 8C. The opening 562 may include a mechanism configured to secure the cover 620 on to the object 610, such as an elastic band that at least partially surrounds the opening 632. According to one aspect of the disclosure, the body 624 can include a sticky or adhesive coating on a surface that faces the object 610 when the cover 620 encloses the object 610.

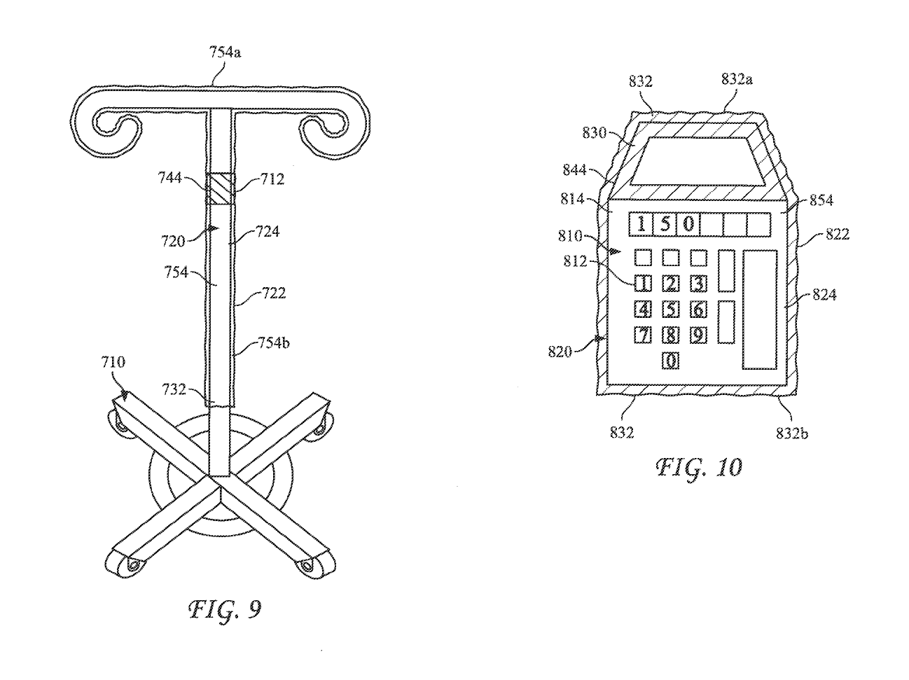

Referring to FIG. 9, an object 710 that includes a surface 712, for example a frequently touched surface, is enclosed, for example partially enclosed or entirely enclosed, by a cover 720. The object 710 may be, for example, an intravenous pole as shown in the illustrated embodiment. The cover 720 may be configured similarly to the covers 20, 120, 220, 320, 420, 520, and 620 (described in detail in reference to FIGS. 1A-8C above) in many aspects such that the descriptions of the covers 20, 120, 220, 320, 420, 520, and 620 herein can be applied to the cover 720, and vice versa. Some similar elements of the cover 720 are identified below bearing the same reference numbers as the corresponding elements of the covers 20, 120, 220, 320, 420, 520, and 620, but increased by 700, 600, 500, 400, 300, 200 and 100, respectively. Differences between the cover 720 and the covers 20, 120, 220, 320, 420, 520, and 620 are also described below.

According to one aspect of the disclosure, the cover 720 defines an outer perimeter 722, and the cover 720 includes a body 724 that extends to and terminates at the outer perimeter 722. The body 724 may be flexible, for example expandable, such that a size, shape, or both of the body 724 may be configured to fit a plurality of objects with various sizes and shapes. For example, the body 724 may correspond generally to a shape of an intravenous pole.

According to one aspect of the disclosure, the body 724 may include a multi-layer portion 744 and a transparent portion 754, the transparent portion 754 including a first sub-portion 754a of the transparent portion 754 and a second sub-portion 754b of the transparent portion 754. The multi-layer portion 744 may be positioned closer to an opening 732 of the cover 720, than the first sub-portion 754a is positioned to the opening 732, and the multi-layer portion 744 may be positioned further from the opening 732 than the second sub-portion 754b is positioned to the opening 732 and is associated with an area that is commonly contacted when moving the object 710.

Referring to FIG. 10, an object 810 that includes a surface 812, for example a frequently touched surface, is enclosed, for example partially enclosed or entirely enclosed, by a cover 820. The object 810 may be, for example, an intravenous pump as shown in the illustrated embodiment. The cover 820 may be configured similarly to the covers 20, 120, 220, 320, 420, 520, 620, and 720 (described in detail in reference to FIGS. 1A-9 above) in many aspects such that the descriptions of the covers 20, 120, 220, 320, 420, 520, 620, and 720 herein can be applied to the cover 820, and vice versa. Some similar elements of the cover 820 are identified below bearing the same reference numbers as the corresponding elements of the covers 20, 120, 220, 320, 420, 520, 620, and 720, but increased by 800, 700, 600, 500, 400, 300, 200, and 100, respectively. Differences between the cover 820 and the covers 20, 120, 220, 320, 420, 520, 620, and 720 are also described below.

According to one aspect of the disclosure, the cover 820 defines an outer perimeter 822, and the cover 820 includes a body 824 that extends to and terminates at the outer perimeter 822. The body 824 may be flexible, for example expandable, such that a size, shape, or both of the body 824 may be configured to fit a plurality of objects with various sizes and shapes. For example, the body 824 may correspond generally to a shape of an intravenous pump.

According to one aspect of the disclosure, the cover 820 defines a plurality of openings 832 that each extends through the body 824 thereby providing access, for example for the object 810, from an exterior of the cover 820 to an interior space 830. The plurality of openings 832 may include a first opening 832a and a second opening 832b spaced from, for example opposite from, the first opening 832a. The first opening 832a, the second opening 832b, or both, may include a mechanism configured to secure the cover 820 on to the object 810, such as an elastic band that at least partially surrounds the respective one of the first and second openings 832a and 832b. According to one aspect of the disclosure, the body 824 can include a sticky or adhesive coating on a surface that faces the object 810 when the cover 820 encloses the object 810.

According to one aspect of the disclosure, the body 824 includes a multi-layer portion 844 and a transparent portion 854. The body 824 may be configured to enclose the object 810 such that the transparent portion 854 is aligned with a front surface 814 of the 810, for example a surface that includes the input controls and the displays on the intravenous pump, and the multi-layer portion 844 surrounds the transparent portion 854 and faces a remainder of the object 810, for example a surface of the intravenous pump that is devoid of input controls and displays. As shown the cover 820 may be devoid of a sleeve (similar to the sleeve 160 described above).

Referring to FIGS. 11A and 11B, an object 910 that includes a surface 912, for example a frequently touched surface, is enclosed, for example partially enclosed or entirely enclosed, by a cover 920. The object 910 may be, for example, computer keyboard as shown in the illustrated embodiment. The cover 920 may be configured similarly to the covers 20, 120, 220, 320, 420, 520, 620, 720, and 820 (described in detail in reference to FIGS. 1A-10 above) in many aspects such that the descriptions of the covers 20, 120, 220, 320, 420, 520, 620, 720 and 820 herein can be applied to the cover 920, and vice versa. Some similar elements of the cover 920 are identified below bearing the same reference numbers as the corresponding elements of the covers 20, 120, 220, 320, 420, 520, 620, 720, and 820, but increased by 900, 800, 700, 600, 500, 400, 300, 200, and 100, respectively. Differences between the cover 920 and the covers 20, 120, 220, 320, 420, 520, 620, 720, and 820 are also described below.

According to one aspect of the disclosure, the cover 920 defines an outer perimeter 922, and the cover 920 includes a body 924 that extends to and terminates at the outer perimeter 922. The body 924 may be flexible, for example expandable, such that a size, shape, or both of the body 924 may be configured to fit a plurality of objects with various sizes and shapes. For example, the body 924 may correspond generally to a shape of a computer keyboard.

According to one aspect of the disclosure, the cover 920 defines an opening 932 that each extends through the body 924 thereby providing access, for example for the object 910, from an exterior of the cover 920 to an interior space 930. The opening 932 may include a mechanism configured to secure the cover 920 on to the object 910, such as an elastic band that at least partially surrounds the opening 932. According to one aspect of the disclosure, the body 924 can include a sticky or adhesive coating on a surface that faces the object 910 when the cover 920 encloses the object 910.

According to one aspect of the disclosure, the body 924 includes a multi-layer portion 944 and a transparent portion 954. The body 924 may be configured to enclose the object 910 such that the transparent portion 954 is aligned with a front surface 914 of the object 910, for example a surface that includes the input controls, or keys on the computer keyboard, and the multi-layer portion 944 surrounds the transparent portion 954 and faces a remainder of the object 910, for example a surface of the computer keyboard that is devoid of input controls and keys. As shown the cover 920 may be devoid of a sleeve (similar to the sleeve 160 described above). Alternatively, the cover 920 may include a sleeve (not shown) that encloses a connector, such as a wire, that electrically connects the computer keyboard to a computer.

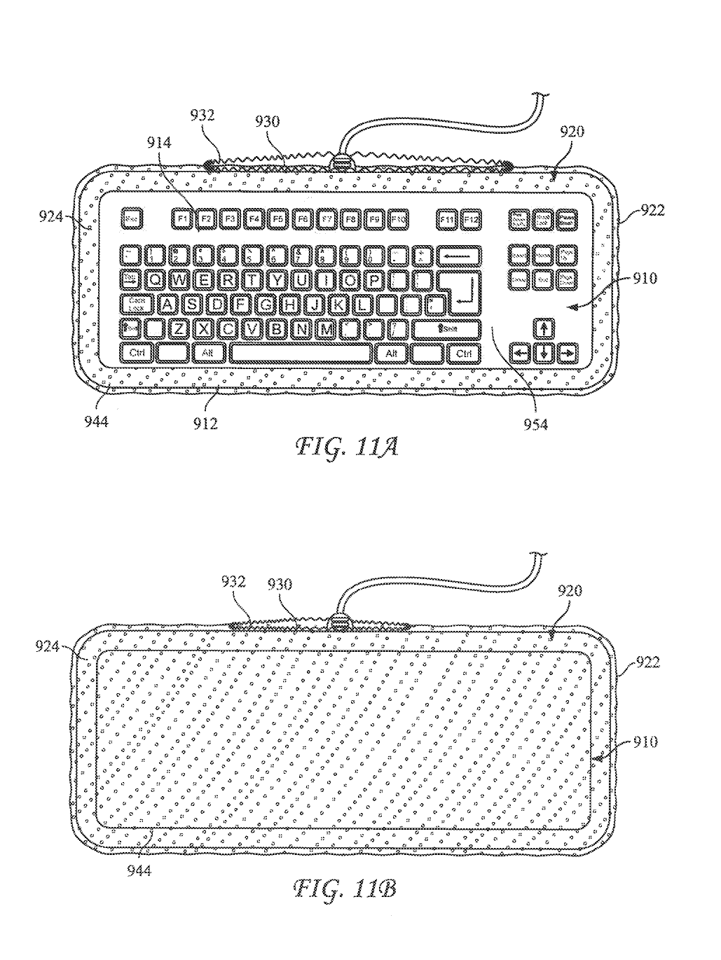

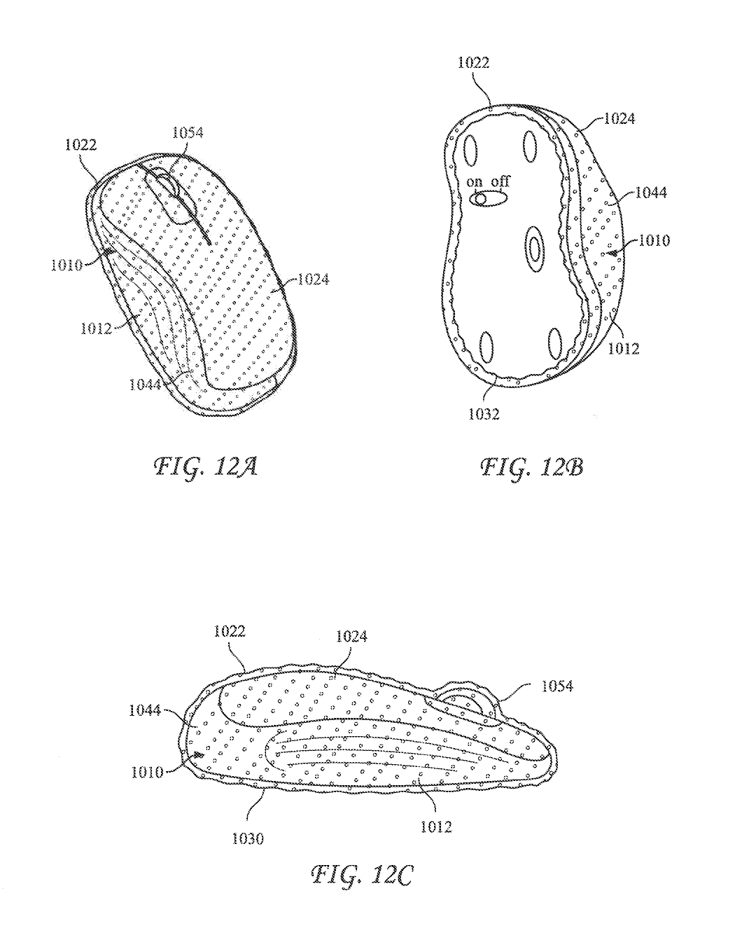

Referring to FIGS. 12A-12C, an object 1010 that includes a surface 1012, for example a frequently touched surface, is enclosed, for example partially enclosed or entirely enclosed, by a cover 1020. The object 1010 may be, for example, computer mouse as shown in the illustrated embodiment. The cover 1020 may be configured similarly to the covers 20, 120, 220, 320, 420, 520, 620, 720, 820, and 920 (described in detail in reference to FIGS. 1A-11B above) in many aspects such that the descriptions of the covers 20, 120, 220, 320, 420, 520, 620, 720, 820, and 920 herein can be applied to the cover 1020, and vice versa. Some similar elements of the cover 1020 are identified below bearing the same reference numbers as the corresponding elements of the covers 20, 120, 220, 320, 420, 520, 620, 720, 820, and 920, but increased by 1000, 900, 800, 700, 600, 500, 400, 300, 200, and 100, respectively. Differences between the cover 1020 and the covers 20, 120, 220, 320, 420, 520, 620, 720, 820, and 920 are also described below.

According to one aspect of the disclosure, the cover 1020 defines an outer perimeter 1022, and the cover 1020 includes a body 1024 that extends to and terminates at the outer perimeter 1022. The body 1024 may be flexible, for example expandable, such that a size, shape, or both of the body 1024 may be configured to fit a plurality of objects with various sizes and shapes. For example, the body 1024 may correspond generally to a shape of a computer mouse.

According to one aspect of the disclosure, the cover 1020 defines an opening 1032 that extends through the body 1024 thereby providing access, for example for the object 1010, from an exterior of the cover 1020 to an interior space 1030. As shown, the opening 1032 may be configured such that when the object 1010 is enclosed by the cover 1020, the opening 1032 is aligned with a power switch, a laser aperture, a plurality of feet, or any combination thereof.

According to one aspect of the disclosure, the body 1024 includes a multi-layer portion 1044 and a transparent portion 1054. The body 1024 may be configured to enclose the object 1010 such that the transparent portion 1054 is aligned with an input device of the object 1010, for example a wheel of the computer mouse. The transparent portion 1054 may be configured such that the input device is actuatable, for example the wheel is scrollable or rotatable, when the cover 1020 encloses the object 1010. As shown, the transparent portion 1054 is raised with respect to the surrounding area of the body 1024.

The body 1024 may further be configured such that the multi-layer portion 1044 surrounds the transparent portion 1054 and faces a remainder of the object 1010, for example another surface of the computer mouse that includes input control, such as left and right mouse buttons. As shown the cover 1020 may be devoid of a sleeve (similar to the sleeve 160 described above). Alternatively, the cover 1020 may include a sleeve (not shown) that encloses a connector, such as a wire, that electrically connects the computer mouse to a computer.

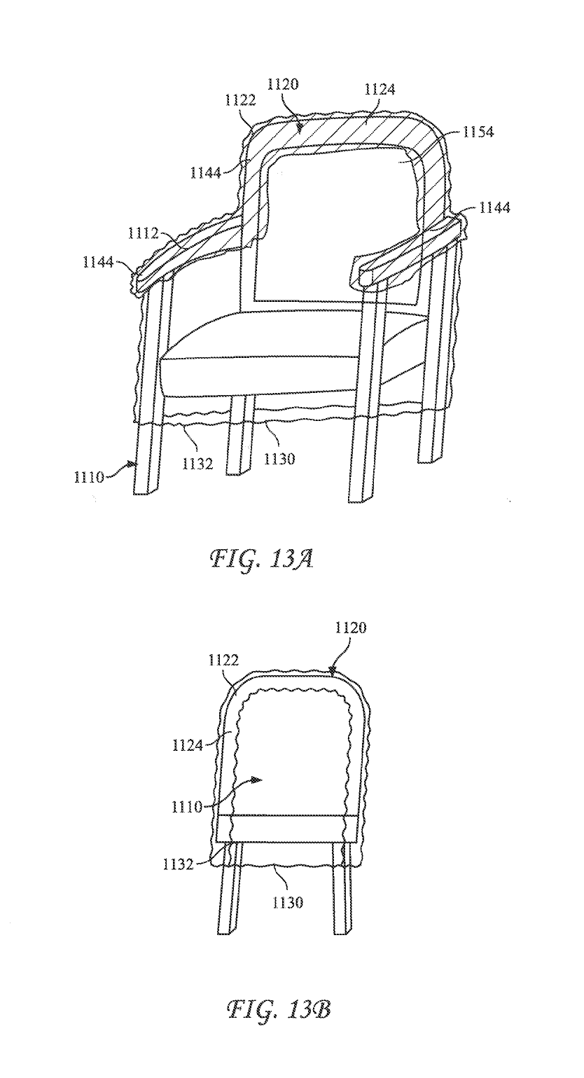

Referring to FIGS. 13A-13B, an object 1110 that includes a surface 1112, for example a frequently touched surface, is enclosed, for example partially enclosed or entirely enclosed, by a cover 1120. The object 1110 may be, for example, a chair as shown in the illustrated embodiment. The cover 1120 may be configured similarly to the covers 20, 120, 220, 320, 420, 520, 620, 720, 820, 920, and 1020 (described in detail in reference to FIGS. 1A-12C above) in many aspects such that the descriptions of the covers 20, 120, 220, 320, 420, 520, 620, 720, 820, 920, and 1020 herein can be applied to the cover 1120, and vice versa. Some similar elements of the cover 1120 are identified below bearing the same reference numbers as the corresponding elements of the covers 20, 120, 220, 320, 420, 520, 620, 720, 820, 920, and 1020, but increased by 1100, 1000, 900, 800, 700, 600, 500, 400, 300, 200, and 100, respectively. Differences between the cover 1020 and the covers 20, 120, 220, 320, 420, 520, 620, 720, 820, 920, and 1020 are also described below.

According to one aspect of the disclosure, the cover 1120 defines an outer perimeter 1122, and the cover 1120 includes a body 1124 that extends to and terminates at the outer perimeter 1122. The body 1124 may be flexible, for example expandable, such that a size, shape, or both of the body 1124 may be configured to fit a plurality of objects with various sizes and shapes. For example, the body 1124 may correspond generally to a shape of a chair.

According to one aspect of the disclosure, the cover 1120 defines an opening 1132 that extends through the body 1124 thereby providing access, for example for the object 1110, from an exterior of the cover 1120 to an interior space 1130. As shown, the opening 1132 may be configured such that when the object 1110 is enclosed by the cover 1120, the opening 1132 is aligned with rear side of the chair.

According to one aspect of the disclosure, the body 1124 includes a multi-layer portion 1144 and a transparent portion 1154. The body 1124 may be configured to enclose the object 1110 such that the multi-layer portion 1144 is aligned with arms and a top of a seat back of the chair. The body 1124 may further be configured to enclose the object 1110 such that the transparent portion 1154 faces or is aligned with a remainder of the object 1110, for example a seating cushion of the chair. The body 1124 may be configured such that the multi-layer portion 1144 and the transparent portion 1154 each define a portion of the perimeter 1122 of the body 1124. Alternatively, an entirety of the body 1124 could define the multi-layer portion 1144. As shown the cover 1120 may be devoid of a sleeve (similar to the sleeve 160 described above). Alternatively, the cover 1120 may include one or more sleeves (not shown) that each enclose a leg of the chair.

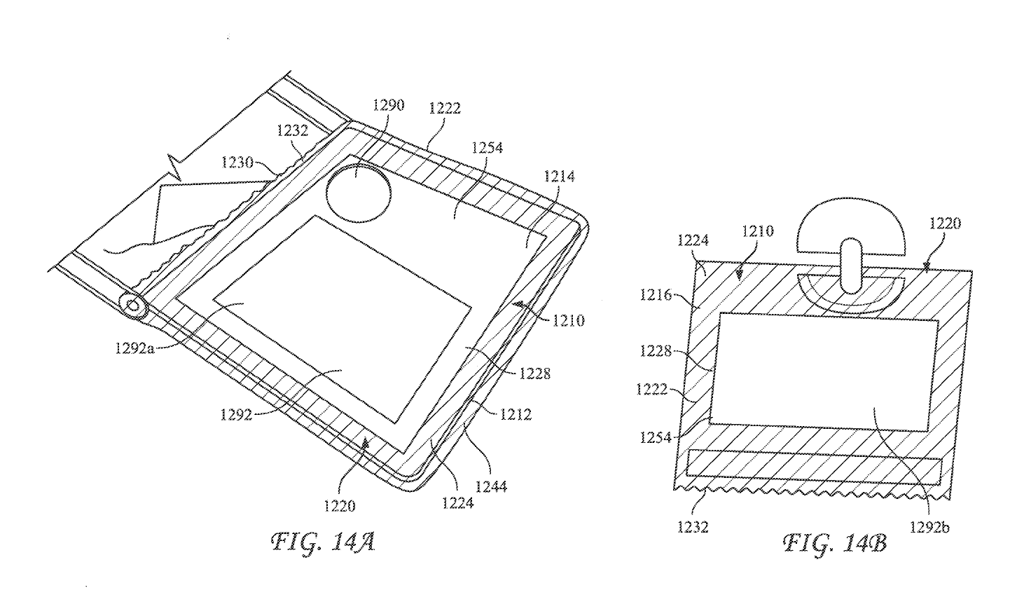

Referring to FIGS. 14A and 14B, an object 1210 that includes a surface 1212, for example a frequently touched surface, is enclosed, for example partially enclosed or entirely enclosed, by a cover 1220. The object 1210 may be, for example, a fold down tray table that may be positioned on a back side of a seat in an airplane. The cover 1220 may be configured similarly to the covers 20, 120, 220, 320, 420, 520, 620, 720, 820, 920, 1020, and 1120 (described in detail in reference to FIGS. 1A-13B above) in many aspects such that the descriptions of the covers 20, 120, 220, 320, 420, 520, 620, 720, 820, 920, 1020, and 1120 herein can be applied to the cover 1220, and vice versa. Some similar elements of the cover 1220 are identified below bearing the same reference numbers as the corresponding elements of the covers 20, 120, 220, 320, 420, 520, 620, 720, 820, 920, 1020, and 1120, but increased by 1200, 1100, 1000, 900, 800, 700, 600, 500, 400, 300, 200, and 100, respectively. Differences between the cover 1220 and the covers 20, 120, 220, 320, 420, 520, 620, 720, 820, 920, 1020, and 1120 are also described below.

According to one aspect of the disclosure, the cover 1220 defines an outer perimeter 1222, and the cover 1220 includes a body 1224 that extends to and terminates at the outer perimeter 1222. The body 1224 may be flexible, for example expandable, such that a size, shape, or both of the body 1224 may be configured to fit a plurality of objects with various sizes and shapes. For example, the body 924 may correspond generally to a shape of a fold down tray table.

The cover 1220 defines an opening 1232 that extends through the body 1224 thereby providing access, for example for the object 1210, from an exterior of the cover 1220 to an interior space 1230 that is configured to enclose the object 1210. The opening 1232 may include a mechanism configured to secure the cover 1220 on to the object 1210, such as an elastic band that at least partially surrounds the opening 1232. According to one aspect of the disclosure, the body 1224 can include a sticky or adhesive coating on a surface that faces the object 1210 when the cover 1220 encloses the object 1210. The body 1224 may further define a multi-layer portion 1244 and a transparent portion 1254. According to one aspect of the disclosure, one section or a plurality of separate sections of the body 1224 can define the multi-layer portion 1244. Alternatively, an entirety of the body 1224 can define the multi-layer portion 1244.

As shown, the multi-layer portion 1244 is positioned at the outer perimeter 1222, for example such that the multi-layer portion 1244 at least partially defines the outer perimeter 1222 of the cover 1220. The multi-layer portion 1244 may be configured such that when the cover 1220 encloses the object 1210 within the interior space 1230, the multi-layer portion 1244 aligns with a frequently touched surface of the object 1210. For example, the cover 1220 may include a multi-layer portion 1244 that is configured to be aligned with an outer perimeter of a fold down tray table when the fold down tray table is enclosed within the interior space 1230 of the cover 1220. Alternatively, the entirety of the body 1224 can define the multi-layer portion 1244.

One or more separate sections of the body 1224 can define the transparent portion 1254. Alternatively, the entirety of the body 1224 can define the transparent portion 1254. As shown, the transparent portion 1254 is surrounded by the multi-layer portion 1244. Also as shown, a first area of the body 1224 that defines the transparent portion 54 may be surrounded by a second area of the body 1224 that defines the multi-layer portion 1244.

According to one aspect of the disclosure, the cover 1220 may include an antimicrobial property, for example carried by any or any combination of surfaces or layers of the cover 1220. The cover 1220 may be configured to be puncture resistant, the cover 1220 may include an adhesive, for example carried by a surface of the cover 1220 that faces the object 1210, the cover 1220 may include printing, for example carried by an outer surface 1228, the cover 1220 may include at least a portion that is colored one of a plurality of colors. According to one aspect of the disclosure, the transparent portion 1254 may be colored one or more of the plurality of colors such that the transparent portion 1254 remains transparent.

The body 1224 may further include a recessed portion 1290 that extends in toward the surface 1212, but not all the way through the body 1224, when the cover 1220 encloses the object 1210. The body 1224 may further include an advertisement 1292 or other information carried by, for example printed on, the body 1224 such that the advertisement 1292 or other information is visible from an exterior of the cover 1220.

According to one aspect of the disclosure the object 1210 defines a first configuration and a second configuration, and the cover 1220 is configured to enclose the object 1210 when the object 1210 is in both the first configuration and the second configuration. In the first configuration the fold down tray table may be folded down such that a front surface 1214 is visible to a person seated in proximity to the object 1210. In the second configuration the fold down tray table may be folded up, for example in a locked position, such that a rear surface 1216, opposite the front surface 1214, is visible to a person seated in proximity to the object 1210. As shown, the cover 1220 may include a first portion 1292a configured to carry a first advertisement visible when the object 1210 is in the first configuration, a second portion 1292b configured to carry a second advertisement visible when the object 1210 is in the second configuration, or both the first portion 1292a and the second portion 1292b such that one of the first and second advertisements is visible whether the object 1210 is in the first configuration or the second configuration.

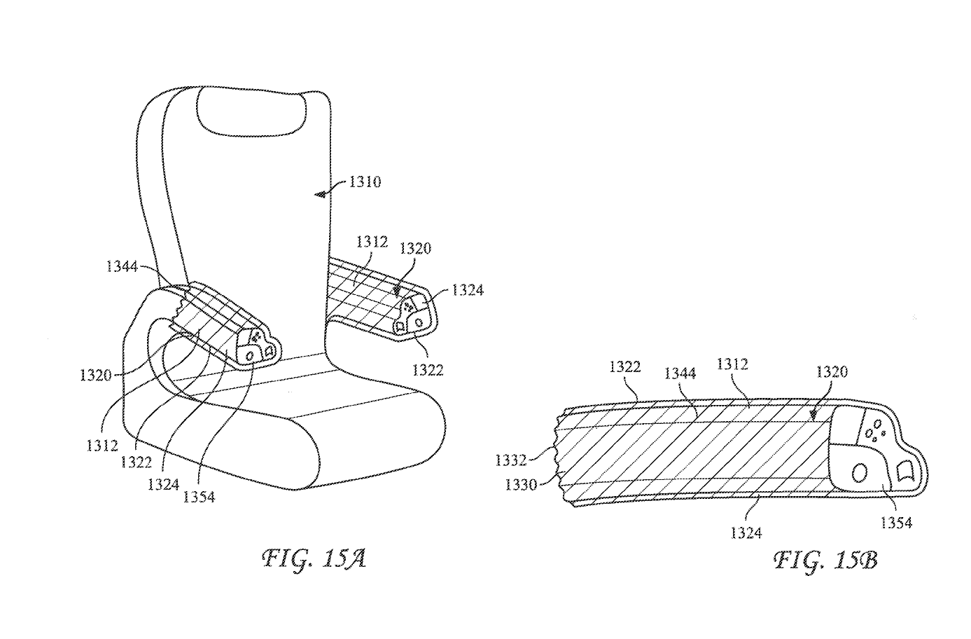

Referring to FIGS. 15A and 15B, an object 1310 that includes a surface 1312, for example a frequently touched surface, is enclosed, for example partially enclosed or entirely enclosed, by a cover 1320. The object 1310 may be, for example, a seat that may be positioned on an airplane. The cover 1320 may be configured similarly to the covers 20, 120, 220, 320, 420, 520, 620, 720, 820, 920, 1020, 1120, and 1220 (described in detail in reference to FIGS. 1A-14B above) in many aspects such that the descriptions of the covers 20, 120, 220, 320, 420, 520, 620, 720, 820, 920, 1020, 1120, and 1220 herein can be applied to the cover 1320, and vice versa. Some similar elements of the cover 1320 are identified below bearing the same reference numbers as the corresponding elements of the covers 20, 120, 220, 320, 420, 520, 620, 720, 820, 920, 1020, 1120, and 1220, but increased by 1300, 1200, 1100, 1000, 900, 800, 700, 600, 500, 400, 300, 200, and 100, respectively. Differences between the cover 1320 and the covers 20, 120, 220, 320, 420, 520, 620, 720, 820, 920, 1020, 1120, and 1220 are also described below.

According to one aspect of the disclosure, the cover 1320 defines an outer perimeter 1322, and the cover 1320 includes a body 1324 that extends to and terminates at the outer perimeter 1322. The body 1324 may be flexible, for example expandable, such that a size, shape, or both of the body 1324 may be configured to fit a plurality of objects with various sizes and shapes. For example, the body 1324 may correspond generally to a shape of an arm of a chair. The body 1324 may include a multi-layer portion 1344. According to one aspect of the disclosure, an entirety of the body 1324 can define the multi-layer portion 1344 such that the body 1324 is devoid of a transparent portion. Alternatively, a portion of the body 1324 can define the multi-layer portion 1344 and the body 1324 can include a transparent portion 1354. For example, the cover 1320 can be configured to enclose an arm of a chair such that the multi-layer portion 1344 is substantially aligned with and substantially covers an upper surface of the arm of the chair, the transparent portion 1354 is aligned with a surface of the arm of the chair that include input devices, or both.

According to one aspect of the disclosure, the cover 1320 defines an opening 1332 that extends through the body 1324 thereby providing access, for example for the object 1310, from an exterior of the cover 1320 to an interior space 1330 configured to receive the object 1310. As shown in the illustrated embodiment, the opening 1332 may be configured such that a size of the opening 1332 is adjustable. The opening 1332 may include a mechanism configured to secure the cover 1320 on to the object 1310, such as an elastic band that at least partially surrounds the opening 1332. According to one aspect of the disclosure, the body 1324 can include a sticky or adhesive coating on a surface that faces the object 1310 when the cover 1320 encloses the object 510.

As shown in the illustrated embodiment, two of the covers 1320 can be provided, for example in a kit, such that each of the covers 1320 is configured to enclose one of a pair of arms of a chair.

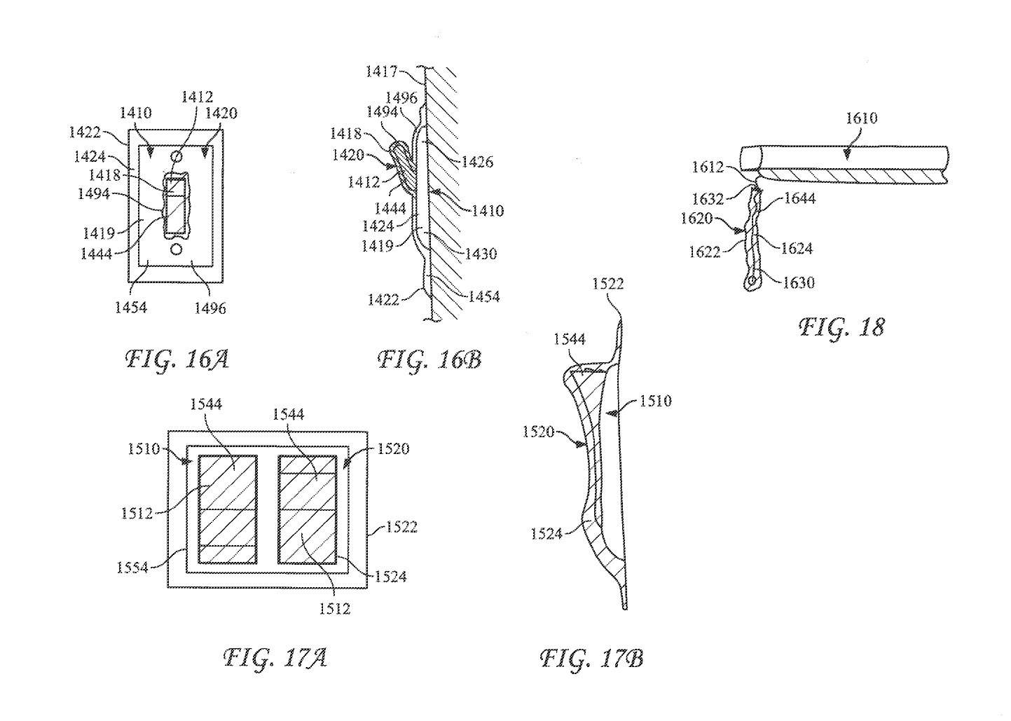

Referring to FIGS. 16A and 16B, an object 1410 that includes a surface 1412, for example a frequently touched surface, is enclosed, for example partially enclosed or entirely enclosed, by a cover 1420. The object 1410 may be, for example, a light switch. The cover 1420 may be configured similarly to the covers 20, 120, 220, 320, 420, 520, 620, 720, 820, 920, 1020, 1120, 1220, and 1320 (described in detail in reference to FIGS. 1A-15B above) in many aspects such that the descriptions of the covers 20, 120, 220, 320, 420, 520, 620, 720, 820, 920, 1020, 1120, 1220, and 1320 herein can be applied to the cover 1420, and vice versa. Some similar elements of the cover 1420 are identified below bearing the same reference numbers as the corresponding elements of the covers 20, 120, 220, 320, 420, 520, 620, 720, 820, 920, 1020, 1120, 1220, and 1320, but increased by 1400, 1300, 1200, 1100, 1000, 900, 800, 700, 600, 500, 400, 300, 200, and 100, respectively. Differences between the cover 1420 and the covers 20, 120, 220, 320, 420, 520, 620, 720, 820, 920, 1020, 1120, 1220, and 1320 are also described below.

According to one aspect of the disclosure, the cover 1420 defines an outer perimeter 1422, and the cover 1420 includes a body 1424 that extends to and terminates at the outer perimeter 1422. The body 1424 may be flexible, for example expandable, such that a size, shape, or both of the body 1424 may be configured to fit a plurality of objects with various sizes and shapes. For example, the body 1424 may correspond generally to a shape of a light switch.

The body 1424 includes an inner portion 1494 and an outer peripheral portion 1496 that is between the outer perimeter 1422 and the inner portion 1494, such that the outer peripheral portion 1496 surrounds the inner portion 1494. The body 1424 defines an inner surface 1426 that is configured to cooperate with a surface 1417, for example a wall on which the object 1410 is mounted, to define an interior space 1430 that encloses the object 1410. The inner surface 1426 may include an adhesive that secures the cover 1420 to the surface 1417.

According to one aspect of the disclosure, the body 1424 includes a multi-layer portion 1444 that coincides with the inner portion 1494 and a transparent portion 1454 that coincides with the outer peripheral portion 1496. As shown, the multi-layer portion 1444 is configured to face a toggle switch 1418 of the object 1410, and the transparent portion 1454 is configured to face a backer plate 1419 of the object 1410.

The cover 1420 is configured to enclose the object 1410 such that the object 1410 is actuatable from a first position, such as an upward pointing “on” position to a second position, such as a downward pointing “off” position without removing the cover 1420. According to one aspect of the disclosure, the cover 1420 defines a pocket portion configured to enclose the object 1410 such that the object 1410 is actuatable from the first position to the second position, without removing the cover 1420. As shown in the illustrated embodiment, a portion, up to an entirety of the pocket portion may be defined by the multi-layer portion 1444.

Referring to FIGS. 17A and 17B, an object 1510 includes a plurality of portions that each includes a surface 1512, for example a frequently touched surface, is enclosed, for example partially enclosed or entirely enclosed, by a cover 1520. Each of the plurality of objects 1510 may be, for example, a light switch. The cover 1520 may be configured similarly to the covers 20, 120, 220, 320, 420, 520, 620, 720, 820, 920, 1020, 1120, 1220, 1320, and 1420 (described in detail in reference to FIGS. 1A-16B above) in many aspects such that the descriptions of the covers 20, 120, 220, 320, 420, 520, 620, 720, 820, 920, 1020, 1120, 1220, 1320, and 1420 herein can be applied to the cover 1520, and vice versa. Some similar elements of the cover 1520 are identified below bearing the same reference numbers as the corresponding elements of the covers 20, 120, 220, 320, 420, 520, 620, 720, 820, 920, 1020, 1120, 1220, 1320, and 1420, but increased by 1500, 1400, 1300, 1200, 1100, 1000, 900, 800, 700, 600, 500, 400, 300, 200, and 100, respectively. Differences between the cover 1520 and the covers 20, 120, 220, 320, 420, 520, 620, 720, 820, 920, 1020, 1120, 1220, 1320, and 1420 are also described below.

According to one aspect of the disclosure, the cover 1520 is configured to enclose the plurality of portions of the object 1510 such that each of the plurality of portions of the object 1510 is independently actuatable from a first position, such as an upward pointing “on” position to a second position, such as a downward pointing “off” position without removing the cover 1520.

The body 1524 may include a plurality of multi-layer portion 1544 the each faces the surface 1512 of one of the plurality of portions of the object 1510 when the plurality of portions of the object 1510 are enclosed in the cover 1520. Alternatively, the body 1524 may include a single, multi-layer portions 1544 that faces the surface 1512 of each of the plurality of portions of the object 1510 when the object 1510 is enclosed in the cover 1520. The body 1524 may further include a transparent portion 1554 that surrounds the one or more of the multi-layer portions 1544. The cover 1520 may further include an adhesive, for example carried by the transparent portion 1554 that is configured to secure the cover 1520 to a surface.

Referring to FIG. 18, an object 1610 that includes a surface 1612, for example a frequently touched surface, is enclosed, for example partially enclosed or entirely enclosed, by a cover 1620. The object 1610 may be, for example, a light fixture and the frequently touched surface may be a pull cord that activates or deactivates the light fixture. The cover 1620 may be configured similarly to the covers 20, 120, 220, 320, 420, 520, 620, 720, 820, 920, 1020, 1120, 1220, 1320, 1420, and 1520 (described in detail in reference to FIGS. 1A-17B above) in many aspects such that the descriptions of the covers 20, 120, 220, 320, 420, 520, 620, 720, 820, 920, 1020, 1120, 1220, 1320, 1420, and 1520 herein can be applied to the cover 1620, and vice versa. Some similar elements of the cover 1620 are identified below bearing the same reference numbers as the corresponding elements of the covers 20, 120, 220, 320, 420, 520, 620, 720, 820, 920, 1020, 1120, 1220, 1320, 1420, and 1520, but increased by 1600, 1500, 1400, 1300, 1200, 1100, 1000, 900, 800, 700, 600, 500, 400, 300, 200, and 100, respectively. Differences between the cover 1620 and the covers 20, 120, 220, 320, 420, 520, 620, 720, 820, 920, 1020, 1120, 1220, 1320, 1420, and 1520 are also described below.

According to one aspect of the disclosure, the cover 1620 defines an outer perimeter 1622, and the cover 1620 includes a body 1624 that extends to and terminates at the outer perimeter 1622. The body 1624 may be flexible, for example expandable, such that a size, shape, or both of the body 1624 may be configured to fit a plurality of objects with various sizes and shapes. For example, the body 1624 may correspond generally to a shape of a pull cord, for example that is configured to activate or deactivate a light fixture when pulled. The body 1624 includes a multi-layer portion 1644. As shown, substantially an entirety of the body 1624 defines the multi-layer portion 1644 such that the body 1624 may be devoid of a transparent portion (similar to the transparent portion 54 as described above). Alternatively, a portion of the body 1624 may define a transparent portion (similar to the transparent portion 54 as described above).

The body 1624 may include an opening 1632 that provides passage for the object 1610 through the opening 1632 and into an enclosed interior 1630 of the cover 1620. The body 1624 may include a mechanism configured to secure the cover 1620 on to the object 1610, such as an elastic band that at least partially surrounds the opening 1632. According to one aspect of the disclosure, the body 1624 can include a sticky or adhesive coating on a surface that faces the object 1610 when the cover 1620 encloses the object 1610.

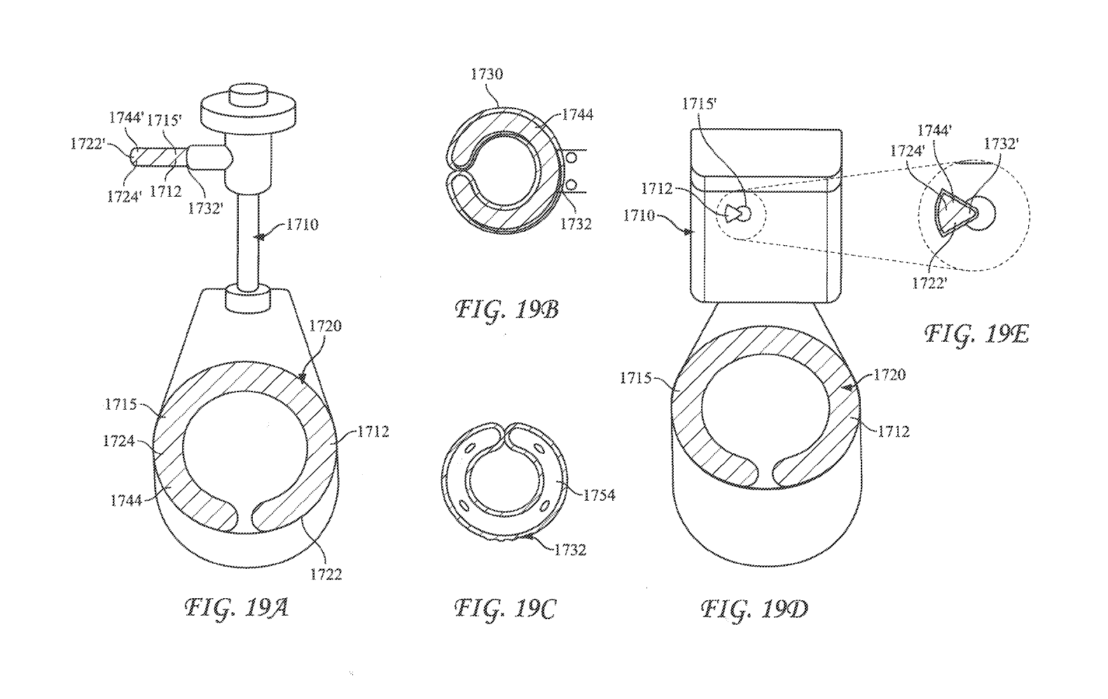

Referring to FIGS. 19A-19E, an object 1710 that includes a plurality of surfaces 1712, for example a plurality of frequently touched surfaces, is enclosed, for example partially enclosed or entirely enclosed, by a cover 1720. The object 1710 may include a first portion 1715 and a second portion 1715′. As shown the object 1710 may be a toilet including a first portion 1715 in the form of a toilet seat and a second portion 1715′ in the form of a flushing mechanism. The cover 1720 may be configured similarly to the covers 20, 120, 220, 320, 420, 520, 620, 720, 820, 920, 1020, 1120, 1220, 1320, 1420, 1520, and 1620 (described in detail in reference to FIGS. 1A-18 above) in many aspects such that the descriptions of the covers 20, 120, 220, 320, 420, 520, 620, 720, 820, 920, 1020, 1120, 1220, 1320, 1420, 1520, and 1620 herein can be applied to the cover 1720, and vice versa. Some similar elements of the cover 1720 are identified below bearing the same reference numbers as the corresponding elements of the covers 20, 120, 220, 320, 420, 520, 620, 720, 820, 920, 1020, 1120, 1220, 1320, 1420, 1520, and 1620 but increased by 1700, 1600, 1500, 1400, 1300, 1200, 1100, 1000, 900, 800, 700, 600, 500, 400, 300, 200, and 100, respectively. Differences between the cover 1720 and the covers 20, 120, 220, 320, 420, 520, 620, 720, 820, 920, 1020, 1120, 1220, 1320, 1420, 1520, and 1620 are also described below.

According to one aspect of the disclosure, the cover 1720 defines a first outer perimeter 1722, and the cover 1720 includes a first body 1724 that extends to and terminates at the first outer perimeter 1722. The cover 1720 may further define a second outer perimeter 1722′, and the cover 1720 may further include a second body 1724′ that extends to and terminates at the second outer perimeter 1722′. The first and second bodies 1724 and 1724′ may each be flexible, for example expandable, such that a size, shape, or both of the first and second bodies 1724 and 1724′ may be configured to fit a plurality of objects with various sizes and shapes. For example, the first body 1724 may correspond generally to a shape of a toilet seat, and the second body 1724′ may correspond generally to a shape of a flushing mechanism of a toilet.

Referring to FIGS. 19A to 19C, according to one aspect of the disclosure, the first body 1724 is configured to enclose a first portion 1715 of the object 1710, and the first body 1724 includes a multi-layer portion 1744 and a transparent portion 1754. The first body 1724 may be configured such that the multi-layer portion 1744 faces the top of the toilet seat and the transparent portion 1754 faces the bottom of the toilet seat when the cover 1720 encloses the first portion 1715 of the object 1710. The first body 1724 further includes an opening 1732 that extends through the body 1724 thereby providing access, for example for the object 1710, from an exterior of the cover 1720 to an interior space 1730 that corresponds in shape to the first portion 1715 of the object 1710, for example the toilet seat.

Referring to FIGS. 19A and 19E, according to one aspect of the disclosure, the second body 1724′ includes a multi-layer portion 1744′. The second body 1724′ may be configured such that an entirety of the second body 1724′ defines the multi-layer portion 1744′ and the second body 1724′ is devoid of a transparent portion. As shown the second body 1724′ may further include an opening 1732′ that extends through the second body 1724′ thereby providing access, for example for the second portion 1715′ of the object 1710, from an exterior of the cover 1720 to an interior space 1730′ that corresponds in shape to the second portion 1715′ of the object 1710, for example the flushing mechanism.

Features of the disclosure which are described above in the context of separate embodiments may be provided in combination in a single embodiment. Conversely, various features of the disclosure that are described in the context of a single embodiment may also be provided separately or in any subcombination.

It will be appreciated by those skilled in the art that changes could be made to the embodiments described above without departing from the broad inventive concept thereof. It is understood, therefore, that this disclosure is not limited to the particular embodiments disclosed, but it is intended to cover modifications within the spirit and scope of the present disclosure as defined by the claims.

1. A disposable cover configured to at least partially enclose an object that includes a frequently touched surface, the cover comprising:
a body including an inner surface and an outer surface opposite the inner surface, the inner surface defining an interior space that is configured to receive the object such that the inner surface faces the object, the body further including a transparent portion, the transparent portion configured such that markings on the object are visible through the body when the object is at least partially enclosed within the interior space, the transparent portion further configured to be liquid impermeable,
wherein the cover defines an opening that provides access from an exterior of the cover to the interior space.

2. The disposable cover of claim 1, wherein the body further comprises a multi-layer portion, the multi-layer portion including an inner layer that is liquid impermeable, an outer layer that is liquid permeable and that at least partially defines the outer surface, and an intermediate layer that is disposed between the inner layer and the outer layer and that includes an absorbent material.

3. The disposable cover of claim 2, wherein the outer layer defines a plurality of holes that provide passage from the outer surface to the intermediate layer.

4. The disposable cover of claim 2, wherein the cover defines an outer perimeter, the body extends to and terminates at the outer perimeter, and the multi-layer portion is positioned at the outer perimeter such that the multi-layer portion at least partially defines the outer perimeter.

5. The disposable cover of claim 2, wherein the cover defines an outer perimeter, the body extends to and terminates at the outer perimeter, and the transparent portion is positioned at the outer perimeter such that the transparent portion at least partially defines the outer perimeter.

6. The disposable cover of claim 2, wherein the inner layer is a first inner layer, the outer layer is a first outer layer, and the intermediate layer is a first intermediate layer, the multi-layer portion includes a first set of layers and a second set of layers, the first set of layers includes the first outer layer, a second inner layer, and the first intermediate layer positioned between the first outer layer and the second inner layer, the second set of layers including the first inner layer, a second outer layer positioned between the second inner layer and the first inner layer, and a second intermediate layer positioned between the second outer layer and the first inner layer.

7. The disposable cover of claim 6, wherein the second inner layer is liquid impermeable, the outer layer is liquid permeable, and the second intermediate layer includes an absorbent material.

8. The disposable cover of claim 6, wherein the first set of layers is configured to be removed by hand, without the use of tools, and without damaging the second set of layers.

9. The disposable cover of claim 1, wherein the body is devoid of any additional openings that provide access from the exterior of the cover to the interior space.

10. The disposable cover of claim 1, wherein the body includes at least one antimicrobial property.

11. (canceled)

12. The disposable cover of claim 1, wherein the body is flexible such that a size of the interior space is adjustable to receive objects of different sizes.

13. The disposable cover of claim 1, wherein the disposable cover is configured to at least partially enclose a side rail of a hospital bed, a footboard of a hospital bed, a headboard of a hospital bed, or a fold down tray table.

14-21. (canceled)

22. The disposable cover of claim 1, wherein the body is puncture resistant.

23. The disposable cover of claim 1, wherein the body includes elastic material that defines the opening and permits a change in size of the opening.

24. The disposable cover of claim 1, further comprising a draw string attached to the body such that a force applied to the draw string changes the size of the opening.

25. The disposable cover of claim 1, wherein the body includes printing.

26. A disposable cover configured to at least partially enclose an object that includes a frequently touched surface, the cover comprising:
a body including an inner surface and an outer surface opposite the inner surface, the inner surface defining an interior space that is configured to receive the object such that the inner surface faces the object, the body further including a multi-layer portion including an inner layer that is liquid impermeable and an outer layer that is liquid permeable and that at least partially defines the outer surface, the outer layer defining a plurality of holes that provide passage through the outer layer from the outer surface toward the inner layer;
wherein the cover defines an opening that provides access from an exterior of the cover to the interior space.

27. The disposable cover of claim 26, wherein the multi-layer portion includes an intermediate layer that is disposed between the inner layer and the outer layer and that includes an absorbent material.

28. The disposable cover of claim 26, wherein each of the plurality of holes extend through the outer surface to the intermediate layer.

29-32. (canceled)

33. The disposable cover of claim 26, wherein the interior space is configured to receive a fold down tray table.
